(19) United States
(12) Patent Application Publication
(10) Pub. No.: US 2026/0004559 A1
(43) Pub. Date: Jan. 1, 2026

(54) IMAGE PROCESSING METHOD AND APPARATUS, DEVICE, AND COMPUTER-READABLE STORAGE MEDIUM

(71) Applicant: TENCENT TECHNOLOGY (SHENZHEN) COMPANY LIMITED, Shenzhen (CN)

(72) Inventor: Cheng ZHU, Shenzhen (CN)

(21) Appl. No.: 19/322,826

(22) Filed: Sep. 9, 2025

Related U.S. Application Data
(63) Continuation of application No. PCT/CN2024/103204, filed on Jul. 2, 2024.

(30) Foreign Application Priority Data
Aug. 9, 2023 (CN) 202310999358.9

(51) Int. Cl. G06V 10/74; G06T 5/50; G06T 5/70; G06T 9/00; G06V 10/762; G06V 20/70

(52) U.S. Cl. CPC G06V 10/761; G06T 5/50; G06T 5/70; G06T 9/00; G06V 10/762; G06V 20/70; G06T 2207/20081; G06T 2207/20084

(57) ABSTRACT

An image processing method includes obtaining a similarity between each image in a database and a reference image, determining an image having a largest similarity in the database as a similar image, determining difference information between the reference image and the similar image, determining a target mask image, in the reference image, for the difference information that highlights a difference object that is in the reference image relative to the similar image and that is determined according to the difference information, performing text expansion expression based on the difference object and the reference image to obtain a difference description text that describes a content difference between the reference image and the similar image, and locally adjusting the similar image according to the target mask image, the difference description text, and the reference image to obtain a target image conforming to a content requirement of the reference image.

### CROSS-REFERENCE TO RELATED APPLICATIONS

This application is a continuation of International Application No. PCT/CN2024/103204, filed on Jul. 2, 2024, which claims priority to Chinese Patent Application No. 202310999358.9, entitled “IMAGE PROCESSING METHOD AND APPARATUS, DEVICE, AND COMPUTER-READABLE STORAGE MEDIUM” and filed with the China National Intellectual Property Administration on Aug. 9, 2023, which are incorporated herein by reference in their entirety.

### FIELD OF THE TECHNOLOGY

This application relates to the field of computer technologies, and in particular, to an image processing method and apparatus, a device, and a computer-readable storage medium.

### BACKGROUND OF THE DISCLOSURE

Artificial intelligence (AI) has been applied to a wide field, and technologies involved in the AI may include computer vision, voice processing, natural language processing, and the like. The computer vision technology has profound significance in an application direction of image processing. For example, different types of image processing tasks may be completed by using the computer vision technology.

To complete an image adjustment task, in a related technology, a target image is generally adjusted based on an existing diffusion model and with reference to description information of image adjustment, to obtain an adjusted image.

During image adjustment, description information is adaptively adjusted while a network parameter of an existing diffusion model keeps unchanged, so that a target image is adjusted based on adjusted description information. This easily ignores many image details, and reduces accuracy of image adjustment. As a result, an image effect after adjustment does not conform to an actual requirement, and subsequent development of a service is not facilitated.

### SUMMARY

In accordance with the disclosure, there is provided an image processing method including obtaining a similarity between each image in a database and a reference image, determining an image having a largest similarity in the database as a similar image, determining difference information between the reference image and the similar image, determining a target mask image, in the reference image, for the difference information that highlights a difference object that is in the reference image relative to the similar image and that is determined according to the difference information, performing text expansion expression based on the difference object and the reference image to obtain a difference description text that describes a content difference between the reference image and the similar image, and locally adjusting the similar image according to the target mask image, the difference description text, and the reference image to obtain a target image conforming to a content requirement of the reference image.

Also, in accordance with the disclosure, there is provided a computer device including a processor and a memory storing a computer program that, when executed by the processor, causes the computer device to obtain a similarity between each image in a database and a reference image, determine an image having a largest similarity in the database as a similar image, determine difference information between the reference image and the similar image, determine a target mask image, in the reference image, for the difference information that highlights a difference object that is in the reference image relative to the similar image and that is determined according to the difference information, perform text expansion expression based on the difference object and the reference image to obtain a difference description text that describes a content difference between the reference image and the similar image, and locally adjust the similar image according to the target mask image, the difference description text, and the reference image to obtain a target image conforming to a content requirement of the reference image.

Also, in accordance with the disclosure, there is provided a non-transitory computer-readable storage medium storing a plurality of instructions that, when executed by a processor, cause a computer device having the processor to obtain a similarity between each image in a database and a reference image, determine an image having a largest similarity in the database as a similar image, determine difference information between the reference image and the similar image, determine a target mask image, in the reference image, for the difference information that highlights a difference object that is in the reference image relative to the similar image and that is determined according to the difference information, perform text expansion expression based on the difference object and the reference image to obtain a difference description text that describes a content difference between the reference image and the similar image, and locally adjust the similar image according to the target mask image, the difference description text, and the reference image to obtain a target image conforming to a content requirement of the reference image.

### BRIEF DESCRIPTION OF THE DRAWINGS

To describe the technical solutions in the embodiments of this application more clearly, the following briefly describes accompanying drawings needed for describing the embodiments. Apparently, the accompanying drawings in the following description show merely some embodiments of this application, and a person skilled in the art may still derive other drawings from these accompanying drawings without creative efforts.

FIG. 1 is a schematic diagram showing a scenario of an image processing system according to an embodiment of this application.

FIG. 2 is a schematic flowchart of operations of an image processing method according to an embodiment of this application.

FIG. 3 is a schematic diagram showing a scenario of generating a global description text according to an embodiment of this application.

FIG. 4 is a schematic diagram showing a scenario of generating an object description text in an image according to an embodiment of this application.

FIG. 5 is a schematic diagram showing a mask segmentation scenario of a mask segmentation model according to an embodiment of this application.

FIG. 6 is a schematic structural diagram of a latent diffusion model according to an embodiment of this application.

FIG. 7 is a schematic structural diagram of a noise reduction network layer in reverse diffusion according to an embodiment of this application.

FIG. 8 is another schematic flowchart of operations of an image processing method according to an embodiment of this application.

FIG. 9 is a schematic structural diagram of a framework of an image processing system according to an embodiment of this application.

FIG. 10 is a schematic structural diagram of a residual network layer according to an embodiment of this application.

FIG. 11 is a schematic diagram showing a scenario of aggregating difference information and generating a difference description text according to an embodiment of this application.

FIG. 12 is a schematic diagram showing a scenario of an image fine adjustment process according to an embodiment of this application.

FIG. 13 is a schematic structural diagram of an image processing apparatus according to an embodiment of this application.

FIG. 14 is a schematic structural diagram of a computer device according to an embodiment of this application.

### DESCRIPTION OF EMBODIMENTS

The following describes in detail implementations of this application. Examples of the implementations are shown in the accompanying drawings, where reference signs that are the same or similar from beginning to end represent same or similar components or components that have same or similar functions. The implementations described below with reference to the accompanying drawings are exemplary, and are only configured for explaining this application and cannot be construed as a limitation to this application.

In some processes described in the specification, the claims, and the foregoing accompanying drawings, a plurality of operations occurring in a specific sequence is included. However, these operations may not be performed in the sequence in which the operations occur in this specification or performed in parallel. The sequence numbers of the operations are merely for distinguishing different operations, and do not indicate any execution sequence. In addition, terms such as “first,” “second,” and the like herein are intended to distinguish similar objects rather than describing specific sequence or chronological order.

The technical solutions in embodiments of this application are clearly and completely described in the following with reference to the accompanying drawings in the embodiments of this application. Apparently, the described embodiments are merely some rather than all of the embodiments of this application. All other embodiments obtained by a person skilled in the art based on the embodiments of this application without creative efforts shall fall within the protection scope of this application.

Embodiments of this application provide an image processing method and apparatus, a device, and a computer-readable storage medium. Specifically, the embodiments of this application are described from a perspective of an image processing apparatus. The image processing apparatus may be specifically integrated into a computer device. The computer device may be a server, or may be a device such as a user terminal. The server may be an independent physical server, or may be a server cluster or a distributed system formed by a plurality of physical servers, or may be a cloud server that provides a basic cloud computing service such as a cloud service, a cloud database, cloud computing, a cloud function, cloud storage, a network service, cloud communication, a middleware service, a domain name service, a security service, a content delivery network (CDN), big data, and an artificial intelligence platform. The user terminal may be a smartphone, a tablet computer, a notebook computer, a desktop computer, a smart speaker, a smartwatch, a smart home appliance, a vehicle-mounted terminal, a smart voice interaction device, an aircraft, or the like, but is not limited thereto.

In a specific implementation of this application, relevant data such as user information, a user usage record, and a user status is involved. When the foregoing embodiments of this application are applied to a specific product or technology, user permission or user agreement is required, and collection, use and processing of the relevant data need to comply with relevant laws, regulations, and standards of relevant countries and regions.

An image processing method provided in embodiments of this application may be applied to any image adjustment scenario. These scenarios are not limited to being implemented by using a cloud service, big data, artificial intelligence, a combination thereof, or the like, and are specifically described by using the following embodiments.

The image processing method provided in the embodiments of this application involves an artificial intelligence (AI) technology. The AI involves a theory, a method, a technology, and an application system that use a digital computer or a machine controlled by the digital computer to simulate, extend, and expand human intelligence, perceive an environment, obtain knowledge, and use knowledge to obtain an optimal result. In other words, the AI is a comprehensive technology in computer science and attempts to understand the essence of intelligence and produce a new intelligent machine that can react in a manner similar to human intelligence. The AI is to study the design principles and implementation methods of various intelligent machines, to enable the machines to have the functions of perception, reasoning, and decision-making.

A computer vision (CV) technology is a science that studies how to use a machine to “see,” and the computer vision further refers to use a camera and a computer instead of human eyes to implement machine vision, such as recognition and measurement of a target, and further perform graphic processing, so that the computer processes the target into an image more suitable for human eyes to observe, or an image transmitted to an instrument for detection. As a scientific discipline, CV studies related theories and technologies and attempts to establish an AI system that can obtain information from images or multidimensional data. The CV technologies generally include technologies such as image processing, image recognition, image semantic understanding, image retrieval, optical character recognition (OCR), video processing, video semantic understanding, video content/behavior recognition, three-dimensional object reconstruction, a 3D technology, virtual reality, augmented reality, synchronous positioning, and map construction, and further include biometric feature recognition technologies such as common face recognition and fingerprint recognition.

However, in the embodiments of this application, image processing may be implemented by using technologies such as image processing, image recognition, and image semantic understanding in the CV technology, to complete an image processing task. Details are described by using the following embodiments.

An image processing scenario is mainly implemented by using an artificial neural network (ANN) model, which is briefly referred to as a “model” below. An image processing process may include a training stage (A) and an application stage (B) of the model. The training stage and the application stage may be implemented through one or a combination of a plurality of devices in an image processing system.

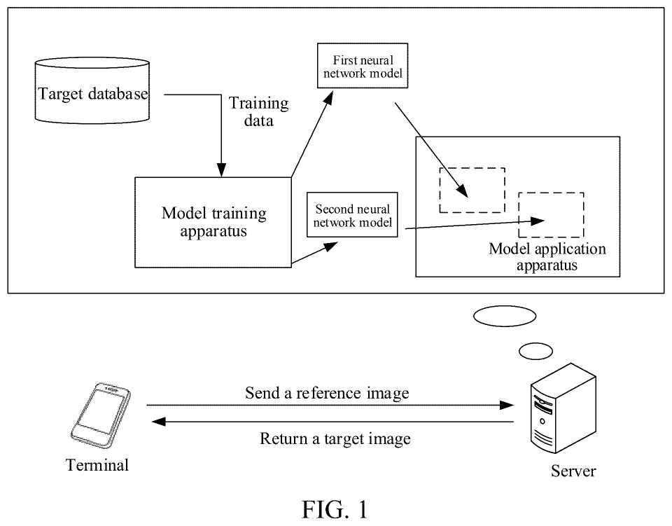

For example, FIG. 1 is a schematic diagram showing a scenario of an image processing system according to an embodiment of this application. The system in the scenario may include a server and/or a terminal. When the system includes only the server or the terminal, the server or the terminal includes a target database, a model training apparatus, and a model application apparatus. When the system is a combination of the terminal and the server, the server may include a target database, a model training apparatus, and a model application apparatus.

The target database may store a large amount of data, and the data includes but is not limited to image data, which is used as a sample similar image in the training stage of the model.

### (A) Training Stage of the Model

In the training stage of the model, after obtaining training data as a sample, the model training apparatus may train a preset model based on the obtained training data. Specifically, the training stage of the model may include preparing training data and model training.

A process of preparing the training data is as follows. First, a sample reference image and a sample target image that needs to be obtained through adjustment are set. Then, a sample similar image similar to the sample reference image may be obtained from the target database. Further, a sample target mask image in the sample reference image and a sample difference description text are generated based on difference information between the sample reference image and the sample similar image. Therefore, the training data is obtained.

Model training may be understood as comparison learning training between an image outputted by the model and the sample target image. In this embodiment of this application, an image adjustment process may include: performing fine adjustment on a similar image by using the sample difference description text as a guiding condition, and performing fine adjustment on the similar image by using the sample reference image as a constraint condition. This may be separately implemented through two models for image fine adjustment. Therefore, a model training process may include training different models. In this case, the sample target image includes a first sample target image and a second sample target image.

With reference to FIG. 1, a model training process in which the sample difference description text is used as the guiding condition is used as an example. Specifically, the model training process includes: performing local fine adjustment on the sample similar image through a preset model based on the sample target mask image and the sample difference description text, to obtain a first prediction image, comparing the first sample target image with the first prediction image, and when there is a difference between the first sample target image and the first prediction image, constructing a prediction loss according to the difference between the first sample target image and the first prediction image, to train the preset model based on the prediction loss; and performing iterative training on the model in the foregoing manner, until a preset model convergence condition is reached. For example, when the first prediction image outputted by the preset model is the same as the first sample target image, when a quantity of times of iterative training reaches a particular quantity, or when the first prediction image outputted by the preset model no longer changes, a trained first neural network model is obtained.

Similarly, with reference to FIG. 1, a model training process in which the sample reference image is used as the constraint condition is used as an example. Specifically, in the process of preparing the training data, in addition to obtaining the sample reference image, the sample target mask image, and the sample similar image, a sample target inverse mask image (namely, a mask image obtained through negation of the sample target mask image) associated with the sample target mask image further needs to be obtained. Further, local fine adjustment is performed on the sample similar image through a preset model based on the sample target inverse mask image and the sample reference image, to obtain a second prediction image. Further, the second sample target image is compared with the second prediction image, and when there is a difference between the second sample target image and the second prediction image, a prediction loss is constructed according to the difference between the second sample target image and the second prediction image, so that iterative training is performed on the preset model based on the prediction loss until a preset model convergence condition is reached, to obtain a trained second neural network model.

So far, the training process based on the model training apparatus ends, and the first neural network model and the second neural network model are separately obtained. The first neural network model and the second neural network model obtained through training may be configured to participate in an image processing process of this application. In the training stage of the model, a conditional latent diffusion (stable diffusion, SD) model may be trained, to obtain the trained first neural network model and second neural network model that belong to the SD model.

In addition, fine adjustment is performed on the sample similar image by using the sample difference description text as the guiding condition, and fine adjustment is performed on the sample similar image by using the sample reference image as the constraint condition. Alternatively, fine adjustment may be performed on an image through a model, to complete image processing. In the training stage of the model, local fine adjustment may be performed on the sample similar image through the preset model based on the sample target mask image, the sample difference description text, and the sample reference image, to obtain a prediction image. Further, the sample target image is compared with the prediction image, and when there is a difference between the sample target image and the prediction image, a prediction loss is constructed according to the difference between the sample target image and the prediction image, so that iterative training is performed on the preset model based on the prediction loss until a preset model convergence condition is reached, to obtain a trained target model.

### (B) Application Stage of the Model

In the application stage of the model, the trained first neural network model and second neural network model may be uploaded to or installed in the model application apparatus, so that the model application apparatus runs the first neural network model and the second neural network model in the image processing process, to cooperate in completing an image processing related procedure. Specifically, the image processing procedure includes: obtaining a reference image, and obtaining a similar image similar to the reference image; determining difference information between the reference image and the similar image; determining a target mask image for the difference information in the reference image, the target mask image being configured for highlighting a difference object that is in the reference image relative to the similar image and that is determined according to the difference information; performing text expansion expression based on the difference object and the reference image, to obtain a difference description text, the difference description text being a text configured for describing a content difference between the reference image and the similar image; performing local fine adjustment on the similar image through the first neural network model based on the target mask image and the difference description text, to generate a first image; performing local fine adjustment on the similar image through the second neural network model based on a target inverse mask image (namely, a mask image obtained through negation of the target mask image) and the reference image, to generate a second image; and fusing the first image and the second image to obtain a target image, the target image being an image conforming to a content requirement of the reference image.

In addition, assuming that fine adjustment is performed on an image through one model, the trained target model may be uploaded to or installed in the model application apparatus, so that the model application apparatus runs the target model in the image processing process, to cooperate in completing the image processing related procedure. The image processing procedure includes: obtaining a reference image, and obtaining a similar image similar to the reference image; determining difference information between the reference image and the similar image; determining a target mask image for the difference information in the reference image, the target mask image being configured for highlighting a difference object that is in the reference image relative to the similar image and that is determined according to the difference information; performing text expansion expression based on the difference object and the reference image, to obtain a difference description text, the difference description text being a text configured for describing a content difference between the reference image and the similar image; and locally adjusting the similar image according to the target mask image, the difference description text, and the reference image, to obtain the target image.

The image processing method of this application may be implemented in the scenario of the training stage and the application stage of the model.

For example, assuming that the server or the terminal includes a target database, a model training apparatus, and a model application apparatus, the server or the terminal may prepare training data based on sample image data in the target database, train a preset model through the model training apparatus according to the training data, and transmit a trained first neural network model and a trained second neural network model to the model application apparatus for running. In this case, the terminal or the server may implement the following case: obtaining a reference image, and obtaining a similar image similar to the reference image; determining difference information between the reference image and the similar image; determining a target mask image for the difference information in the reference image, the target mask image being configured for highlighting a difference object that is in the reference image relative to the similar image and that is determined according to the difference information; performing text expansion expression based on the difference object and the reference image, to obtain a difference description text, the difference description text being a text configured for describing a content difference between the reference image and the similar image; and locally adjusting the similar image according to the target mask image, the difference description text, and the reference image to obtain a target image.

As another example, a system in which the terminal and the server are combined is used as an example. A communication connection is established between the terminal and the server. The server may be a distributed service system including a plurality of physical service organizations, and includes at least a target database, a model training apparatus, and a model application apparatus. After training of a model is completed on the server, a trained first neural network model and a trained second neural network model may be run on the server, or a trained target model may be run on the server, to implement an image processing procedure. Specifically, in the application stage, a reference image may be sent to the server through a client on the terminal. After obtaining the reference image, the server may obtain a similar image similar to the reference image from the target database; determine difference information between the reference image and the similar image; determine a target mask image for the difference information in the reference image, the target mask image being configured for highlighting a difference object that is in the reference image relative to the similar image and that is determined according to the difference information; perform text expansion expression based on the difference object and the reference image, to obtain a difference description text, the difference description text being a text configured for describing a content difference between the reference image and the similar image; and locally adjust the similar image according to the target mask image, the difference description text, and the reference image to obtain a target image. Then, the server may return the target image to the terminal.

For example, as shown in FIG. 1, it is assumed that an image processing application (client) is installed on the terminal, and a user may select an image search task on the image processing application, to execute an image processing process. Specifically, the image processing process is as follows. First, the user may select an image search task on a client page on the terminal, and set, for the image search task, a reference image that needs to be found. Further, the client transmits the reference image to the server. Then, after obtaining the reference image, the server may obtain a similar image similar to the reference image from the target database; determine difference information between the reference image and the similar image; determine a target mask image for the difference information in the reference image, the target mask image being configured for highlighting a difference object that is in the reference image relative to the similar image and that is determined according to the difference information; perform text expansion expression based on the difference object and the reference image, to obtain a difference description text, the difference description text being a text configured for describing a content difference between the reference image and the similar image; and locally adjust the similar image according to the target mask image, the difference description text, and the reference image to obtain a target image. Finally, the server returns, to the client, the target image obtained through local fine adjustment on the similar image, so that an image provided in an image search service can better conform to an actual requirement (the reference image), to facilitate development of the image search service.

The foregoing is merely an example, and may alternatively be applied to another image service. Details are not described herein.

For ease of understanding, operations of the image processing method are separately described in detail. The sequence of the following embodiments is not intended to limit preference orders of the embodiments.

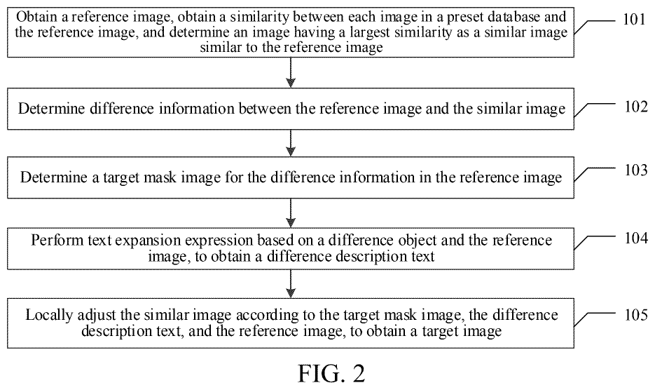

In the embodiments of this application, descriptions are provided from a perspective of an image processing apparatus. The image processing apparatus may be specifically integrated into a computer device such as a terminal or a server. FIG. 2 is a schematic flowchart of operations of an image processing method according to an embodiment of this application. In this embodiment of this application, an example in which an image processing apparatus is specifically integrated on a server is used. When a processor on the server executes a program instruction corresponding to the image processing method, a specific procedure is as follows.

101: Obtain a reference image, obtain a similarity between each image in a preset database and the reference image, and determine an image having a largest similarity as a similar image similar to the reference image.

In this embodiment of this application, after the reference image is obtained, to obtain an image conforming to an actual requirement of the reference image, an image most similar to the reference image may be generally found from existing image data, so that further image processing is subsequently performed on the found similar image. The image processing process may be image adjustment, for example, large adjustment or local adjustment, so that information included in a target image better matches the reference image. For example, the obtained image is closer to the reference image in terms of style and content, and is reliable.

The reference image may be an image including any type of content information, for example, an image including any one or more types of content information selected from e.g., fruit, tableware, animal, human, and animation, or may be an image including content information in another form. This is not listed one by one herein. The reference image may be used as an image adjustment basis in the image processing process, that is, another image may be adjusted based on the reference image.

The similar image may be an image that is in the database and that is most similar to the reference image, and may be understood as an image that is in existing data and that is most similar to the reference image in terms of image content or image style. In this embodiment of this application, the similar image is used as basic data of image adjustment, that is, image adjustment is performed based on the similar image.

For ease of understanding the reference image and the similar image, the two images are described by using an example. For example, an image search service is used as an example. A customer sends an example image to an image search platform through a client. Content information of the example image is that there are two lying cats, and the example image may be considered as a reference image. Further, after receiving the example image sent by the customer, the image search platform may search a database of the platform for a similar image most similar to the example image, so that the similar image is subsequently adjusted based on related information of the reference image, to meet a requirement of the image search service of the customer as much as possible.

In some implementations, to find the similar image similar to the reference image from an existing database, whether any two images are similar may be determined in a feature distance manner, or a similarity between two images is measured by using a feature distance. For example, operation 101 may include: determining a reference cluster center to which the reference image belongs; determining a feature category distance between each preconstructed image cluster center in the preset database and the reference cluster center; and determining, based on the feature category distance, a similarity between an image corresponding to each image cluster center and the reference image, and determining an image having a largest similarity as the similar image similar to the reference image.

Content information included in different images is different, and the images may be classified according to the content information included in the images. For example, for images under an animal subject, the images may be classified into categories according to animal types, for example, classified into categories of cat, dog, tiger, horse, dove, eagle, and other animals. For one or more images belonging to the same category, a cluster center corresponding to the category may be calculated by using the one or more images.

The reference cluster center may be a feature cluster center constructed based on one or more reference images, represents a feature category center point among the one or more reference images, and may be understood as a feature mean point. For example, when there is one reference image, the reference image may be converted into a pixel matrix, and the pixel matrix of the reference image may be considered as a reference cluster center. When there is a plurality of reference images, a pixel matrix of each reference image may be determined, and reference cluster centers of the plurality of reference images are calculated with reference to each pixel matrix. For example, a mean value of a plurality of pixel matrices is used as the reference cluster center. The foregoing is merely an example, and is not used as a specific limiting manner for implementing this application.

The image cluster center may be a cluster center of an image set corresponding to a category in the existing database, and each image cluster center may change according to an update of the image set of each category in the database, that is, the image cluster center may be constructed in real time. For example, the preset database may include images of subjects such as food, animal, plant, vehicle, and ornament, each subject may include one or more image categories, and each image category corresponds to one image cluster center. The animal is used as an example, and it is assumed that an image set of a cat category is included. In this case, each image under the cat category is represented by using each pixel matrix, and a mean value of all pixel matrices under the cat category is calculated and used as an image cluster center corresponding to the cat category. It is assumed that the animal subject further includes a dog category. In this case, a manner of calculating an image cluster center of the dog category is consistent with the manner of calculating “the image cluster center of the cat category.” For an image of any category under another subject, a manner of calculating an image cluster center of the category is the same as that described above. Details are not described herein again.

To select a similar image similar to the reference image from the preset database, after a reference cluster center corresponding to the reference image is determined, a feature category distance between the reference cluster center and each image cluster center in the database may be calculated. Further, the similar image similar to the reference image may be selected according to the feature category distance. Specifically, it may be determined according to a value of the feature category distance that a cluster center of the reference image is closer to which image cluster center in the database, to determine an image category of a closer target image cluster center as an image category of the reference cluster center. Further, a feature distance between the reference image and each image of the image category of the target image cluster center is calculated. A value of the feature distance may reflect a similarity between any two images. Therefore, the similar image similar to the reference image may be selected according to the value of the feature distance. For example, an image having a smallest feature distance to the reference image is selected as the similar image.

In the manner, after a reference image is obtained, an image most similar to the reference image may be found from existing image data, so that further image adjustment is subsequently performed on the found image, to obtain an image that better conforms to an actual requirement of the reference image, which has reliability.

102: Determine difference information between the reference image and the similar image.

In this embodiment of this application, to more accurately adjust the similar image, a difference situation between the reference image and the similar image may be determined, so that the similar image is subsequently adjusted by using the difference situation between the two images as an adjustment basis in an image processing process, to improve accuracy of image adjustment.

The difference information may be information representing a feature difference between the reference image and the similar image, and includes but is not limited to difference information such as a quantity of objects (things) that differ in an image, an object location, and/or an object posture. For example, a reference image includes two orange cats, a 1st orange cat lies on a lawn, and a 2nd orange cat is in a running state in an area around the 1st orange cat. Assuming that a similar image includes two orange cats, one orange cat lies on a lawn, and the other orange cat is in a running state in an area far away from the lying orange cat, difference information between the reference image and the similar image may be a location difference, namely, a location relationship, between the two orange cats. As another example, a reference image includes two orange cats and one blue cat, and a similar image includes two orange cats. In this case, there is a difference object (one blue cat) in difference information between the reference image and the similar image. The difference information may be generated with reference to a difference object and an object location relationship. The foregoing is merely an example, and is not used as a specific limiting manner for implementing this application.

In some implementations, to obtain the difference information between the reference image and the similar image, a difference between the images may be determined according to a description text of the reference image and a description text of the similar image, to generate the difference information. For example, operation 102 may include:

(102.1): Obtain a first description text corresponding to the reference image.

(102.2): Obtain a second description text corresponding to the similar image.

(102.3): Generate the difference information based on a difference between the first description text and the second description text.

The first description text may be an image content description text generated for content information in the reference image. Because the content information in the reference image may include object information and environment information of an object, the first description text includes but is not limited to a global description text for overall content of the reference image and an object description text for an object in the reference image. For example, assuming that a reference image includes two orange cats and one blue cat, a global description text may be “There are two orange cats and one blue cat on a lawn, a 2^{nd} orange cat is located in an upper-right lawn area of a 1^{st} orange cat, and the blue cat is located in an upper-left lawn area of the 1^{st} orange cat,” an object description text for the 1^{st} orange cat is “The orange cat lies on the lawn,” an object description text for the 2^{nd} orange cat is “The orange cat runs on the lawn,” and an object description text for the blue cat is “The blue cat rolls on the lawn.” The global description text and the object description texts are merely examples, and are not used as specific limiting manners for implementing this application. Any of the description texts may alternatively be described in more detail or more concise according to an actual situation.

The second description text may be an image content description text generated for content information in the similar image. Similarly, the second description text includes but is not limited to a global description text for overall content of the similar image and an object description text for an object in the similar image. For a specific example, reference may be made to the descriptions of the first description text. This is not limited herein.

Specifically, to obtain the difference information between the reference image and the similar image, after the first description text of the reference image and the second description text of the similar image are respectively obtained, a difference between the content information in the reference image and the content information in the similar image may be learned according to a description difference between the first description text and the second description text. For example, it is determined whether there is an object quantity difference between the reference image and the similar image, it is determined whether there is an object location distribution difference between the reference image and the similar image, and it is determined whether there is an object posture difference between the reference image and the similar image. The difference between the reference image and the similar image may include one or more of the foregoing cases, and may further include other difference cases. Further, the difference information is obtained based on the foregoing determined difference.

For example, it is assumed that the first description text of the reference image is “There are two orange cats on a lawn, a 1^{st} orange cat lies on the lawn, a 2^{nd} orange cat is located in an upper-right area of the 1^{st} orange cat, and the 2^{nd} orange cat runs on the lawn,” and it is assumed that the second description text of the similar image is “There are two orange cats on a lawn, a 1^{st} orange cat lies on the lawn, a 2^{nd} orange cat is located in an upper-left area of the 1^{st} orange cat, and the 2^{nd} orange cat runs on the lawn.” It can be learned that a difference between the first description text and the second description text is a location distribution difference between the 2^{nd} orange cats (objects) in the images. Therefore, difference information may be generated based on the difference. The difference information may be information about the 2^{nd} orange cat (a difference object) in the reference image, for example, location information, shape information, or size information of the 2^{nd} orange cat. In addition, because an upper-left area of the 1^{st} orange cat in the reference image is the lawn, and the 2^{nd} orange cat exists in the upper-left area of the 1^{st} orange cat in the similar image, the difference information may further include information about the lawn (a difference object) in the upper-left area of the 1^{st} orange cat in the reference image.

For example, it is assumed that the first description text of the reference image is “There are two orange cats and one blue cat on a lawn, a 1^{st} orange cat lies on the lawn, a 2^{nd} orange cat is located in an upper-right area of the 1^{st} orange cat, the 2^{nd} orange cat runs on the lawn, the blue cat is located in an upper-left area of the 1^{st} orange cat, and the blue cat rolls on the lawn,” and it is assumed that the second description text of the similar image is “There are two orange cats on a lawn, a 1^{st} orange cat lies on the lawn, a 2^{nd} orange cat is located in an upper-right area of the 1^{st} orange cat, and the 2^{nd} orange cat runs on the lawn.” It can be learned that a difference between the first description text and the second description text is a cat (object) quantity difference, a cat location distribution difference in the images, and the like. Therefore, difference information may be generated based on the two differences. The difference information may be information about the blue cat (a difference object), for example, an object description text of the blue cat and location information of the blue cat in the reference image.

In some implementations, because both the reference image and the similar image belong to image data, to accurately obtain text information for describing the reference image and the similar image, the first description text of the reference image and the second description text of the similar image may be obtained in an image-to-text conversion manner. For example, obtaining the first description text is used as an example, and operation (102.1) may include:

(102.1.1): Perform global description on the reference image through a first preset model, to generate a global description text of the reference image.

(102.1.2): For each object in the reference image, process, through a second preset model, a pixel area in which the object is located, to obtain an object description text corresponding to the object in the reference image.

(102.1.3): Determine the first description text corresponding to the reference image according to the global description text of the reference image and the object description text corresponding to each object.

The global description text may be understood as a text obtained by integrally describing and summarizing content information included in an image. The image may be quickly understood in a text-based manner by using the global description text. For example, the reference image is used as an example. Assuming that content of the reference image includes a lawn, a flying disc, and a pet dog jumping toward the flying disc, the global description text may be “The pet dog jumps to play the flying disc on the lawn.” As another example, assuming that content of the reference image includes a lawn, a lying orange cat, and a running blue cat, the global description text may be “The orange cat lies on the lawn for rest, and the blue cat runs on the lawn for play.” The foregoing is an example.

The object description text may be a text configured for describing a feature of a corresponding object in an image, and may include descriptions of a color, a shape, a posture, a location, and another aspect of the object. For example, the reference image is used as an example. The object description text may describe information such as a location, an action, a posture, and a shape of a corresponding object in the image. The object description text may include an object category label and object description information. The object category label is configured for indicating a category or a name of a corresponding object. The object description information is configured for specifically describing an action, a location, a shape, a posture, and the like of the object. For example, assuming that content information included in an image is “A brown dog plays a flying disc on a lawn,” an object category label may be “dog” or “brown dog,” and object description information may be “The brown dog plays the flying disc on the lawn.” The foregoing is merely an example, and is not used as a specific limitation to implementation of this application.

The first preset model may be a model configured to perform global text description on an overall situation of an image. For example, the first preset model may be a pre-trained frozen image encoder and a large language model (bootstrapping language-image pre-training with frozen image encoder and large language models, BLIP2), and a large language model (LLM) is introduced into the model.

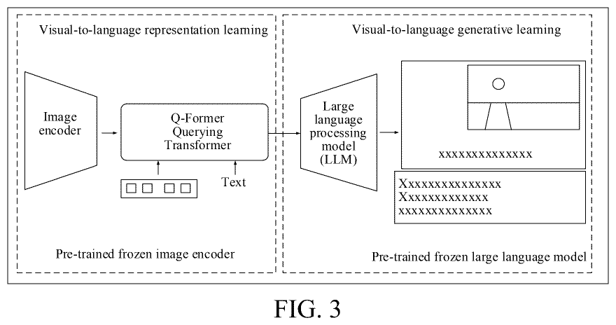

Specifically, with reference to FIG. 3, the first preset model may include two parts of vision-and-language representation learning and vision-to-language generative learning in terms of structure. The visual-and-language representation learning includes an image encoder and a lightweight querying transformer (Q-Former) in terms of structure. The vision-to-language generative learning includes a large language model (LLM) in terms of structure. An example in which global description is performed on the reference image is used. In the first preset model, first, a reference image is inputted into the image encoder, and the reference image is encoded through the image encoder, to obtain an image encoding result. Further, the image encoding result is inputted into the lightweight querying transformer, and an object category label in the reference image is determined, so that the image encoding result is fused with the object category label in the lightweight querying transformer, to obtain a fused feature result. Finally, the fused feature result is inputted into the large language model for language processing, to output a global description text of the reference image.

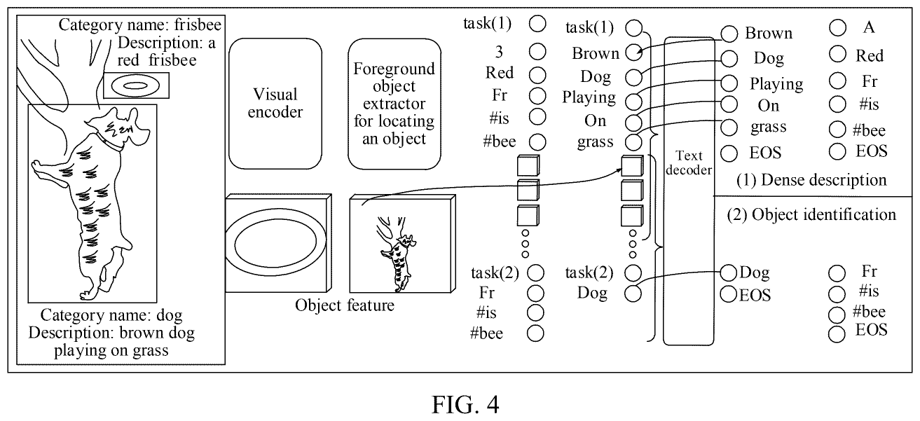

The second preset model may be a model configured to perform text description on an image area including an object in an image. For example, the second preset model may be a generative region-to-text transformer (GRIT). Specifically, with reference to FIG. 4, the second preset model may include a visual encoder, a foreground object extractor for locating an object, and a text decoder in terms of structure. An example in which text description is performed on a pixel area in which each object is located in the reference image is used. First, each object in the reference image is identified, so that the pixel area in which each object is located in the reference image is determined, and a category of each object identified in the reference image is indicated. Then, the reference image in which the pixel area and the category of each object have been determined is inputted into the second preset model. In the second preset model, region-to-language transformation processing is performed on the pixel area in which each object is located through the second preset model, and a reference image obtained through transformation processing is outputted. The reference image obtained through transformation processing includes a marking box configured for marking each object, and an object description text of an object in each marking box.

Further, after the global description text of the reference image and the object description text are obtained, the global description text and the object description text may be combined, to obtain the first description text of the reference image.

In this embodiment of this application, for a manner of obtaining the second description text of the similar image, reference may be made to the process of obtaining the “first description text of the reference image.” Details are not described herein again.

In the manner, a difference situation between the reference image and the similar image may be determined, so that the similar image is more accurately adjusted subsequently by using the difference situation between the two images as an adjustment basis in an image processing process.

103: Determine a target mask image for the difference information in the reference image.

In this embodiment of this application, after it is determined that the similar image needs to be adjusted, image processing may be performed in a local adjustment manner. To locally adjust the similar image, a mask image for the difference information in the reference image needs to be obtained, so that local fine adjustment is performed on the similar image by using the mask image, to subsequently improve accuracy of image adjustment. The target mask image is configured for highlighting a difference object that is in the reference image relative to the similar image and that is determined according to the difference information.

The target mask image may be a pixel area mask image generated for the difference information between the reference image and the similar image, and is configured for masking some pixel areas in the similar image when fine adjustment is performed on the similar image, so that the masked pixel areas of the similar image are blank (there is no content).

In some implementations, the target mask image may be constructed according to the difference object in the reference image relative to the similar image. For example, operation 103 may include:

(103.1): Determine the difference object in the reference image relative to the similar image according to the difference information.

(103.2): Generate the target mask image based on the difference object in the reference image.

Specifically, to obtain the target mask image for the difference information in the reference image, after the difference information is obtained, the difference object included in the reference image relative to the similar image may be determined according to the difference information, so that the target mask image is generated according to the determined difference object. When the target mask image is generated, an initial mask image having the same size as the reference image may be first constructed, then related information of the difference object is used as indication information, and the target mask image is generated according to the indication information, the initial mask image, and the reference image.

In some implementations, the target mask image for the difference information in the reference image may be obtained in a semantic segmentation manner. For example, operation (103.2) may include: constructing an initial mask image having the same size as the reference image; obtaining indication information of the difference object in the reference image, the indication information including but is not limited to a pixel area of a background of the difference object, a marking box, an object description text, and the like; and generating the target mask image based on the initial mask image, the indication information, and the reference image through a semantic segmentation model.

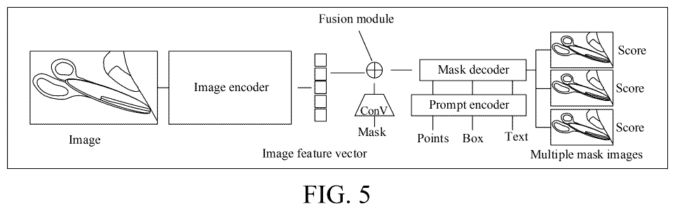

The mask segmentation model (segmenting everything) is configured to generate a mask image of any image according to the indication information. With reference to FIG. 5, the model may include an image encoder, a convolutional module (conv), a fusion module, an indication information encoder (prompt encoder), and a mask image decoder (mask decoder) in terms of structure. Specifically, a reference image is inputted into the mask segmentation model, the reference image is encoded through the image encoder, to obtain an image vector, and feature extraction is performed on an initial mask image through the convolutional module (conv), to obtain a mask image vector. Further, the image vector and the mask image vector are fused, to obtain an image fused feature. In addition, indication information is encoded through the indication information encoder (prompt encoder), where the indication information may include a pixel area (point) of a background of a difference object, a marking box (box), and an object description text (text), to obtain an encoded feature of the indication information, and the image fused feature and the encoded feature of the indication information are decoded through the mask image decoder (mask decoder), to output one or more prediction mask images. When only one prediction mask image is outputted, the prediction mask image is used as the target mask image. When a plurality of prediction mask images are outputted, each prediction mask image has a corresponding score, and a prediction mask image having a largest score may be selected as the target mask image.

For ease of understanding a generation principle of the target mask image, the following describes the target mask image by using a scenario example. Specifically, for example, it is assumed that a reference image includes two orange cats, a 1^{st} orange cat lies on a lawn, and a 2^{nd} orange cat runs in an upper-right area of the 1^{st} orange cat. A similar image includes two orange cats, a 1^{st} orange cat lies on a lawn, and a 2^{nd} orange cat runs in an upper-left area of the 1^{st} orange cat. Difference information includes information about the 2^{nd} orange cat in the reference image, and information about the lawn in the upper-right area of the 1^{st} orange cat, for example, location distribution information, size information, and shape information. Further, after an initial mask image having the same size as the reference image is constructed, a target mask image may be generated for the obtained difference information. The target mask image is mainly configured for masking a pixel area in which the 2^{nd} orange cat is located in the similar image during image processing, and masking a pixel area of the lawn in the upper-left area of the 1^{st} orange cat in the similar image. In this case, in the target mask image, the two pixel areas are represented by using “0,” and all pixel areas except the two areas in the target mask image are represented by using “1.”

In the manner, the target mask image for the difference information in the reference image relative to the similar image may be obtained, so that local fine adjustment is performed on the similar image by using the target mask image as a needed element when the similar image is adjusted, to subsequently improve accuracy of image adjustment.

104: Perform text expansion expression based on the difference object and the reference image, to obtain a difference description text.

In this embodiment of this application, to locally adjust the similar image, in addition to obtaining the mask image for the difference information in the reference image, a related description text of the difference information in the reference image further needs to be obtained, so that the similar image is locally adjusted subsequently by using the related description text of the difference information as a guiding condition for image adjustment, to improve accuracy of image adjustment.

The difference description text may be a text for describing a content difference between the reference image and the similar image, is mainly obtained by performing text expansion expression based on the difference information, and can abundantly and accurately represent a difference between the reference image and the similar image. The difference description text may be used as the guiding condition for adjusting the similar image, to participate in local adjustment on the similar image, to improve accuracy of image adjustment.

In some implementations, because the difference information may reflect a difference between the reference image and the similar image, to obtain a description text configured for fully describing the difference between the two images, expansion description may be performed based on a relationship between the difference object and another object in the reference image and an object description text of the difference object, to obtain a description text for the difference between the two images, namely, the difference description text. For example, operation 104 may include:

(104.1): Determine the difference object in the reference image relative to the similar image according to the difference information.

(104.2): For each object in the reference image, determine object relationship information between the difference object and the object.

(104.3): Obtain a global description text of the reference image and a target object description text of the difference object.

(104.4): Perform text expansion based on the global description text, the target object description text, and the object relationship information, to obtain the difference description text.

The object relationship information may be information indicating a relationship between the difference object and any object. The object relationship includes but is not limited to a location distribution relationship (for example, a distance and a direction), a category relationship (whether the difference object and the object belong to the same-species attribute), and the like between the difference object and another object. For example, object elements of the reference image include a lawn, one orange cat, and one blue cat, the orange cat lies in a lawn area at a center location of the reference image, and the blue cat is located on the lawn in an upper-right area of the orange cat. Object elements of the similar image also include a lawn, one orange cat, and one blue cat, but a difference lies in that the blue cat in the similar image is located on the lawn in an upper-left area of the orange cat. It can be learned that the difference object in the reference image relative to the similar image may include at least the blue cat. An example in which the blue cat is used as the difference object is used. Object relationship information may include a location distribution relationship between the blue cat and the orange cat in the reference image (for example, the blue cat is located in the upper-right area of the orange cat), and a category relationship between the blue cat and the orange cat (the blue cat and the orange cat belong to the same-species category).

Specifically, to abundantly describe the difference information between the reference image and the similar image, first, a difference object corresponding to the difference information in the reference image may be determined, and object relationship information between the difference object and any other object in the reference image is obtained. For example, a current location relationship between the difference object and another object in the image is determined, or it is determined whether the difference object and the another object belong to the same object category. Further, with reference to obtaining of the “first description text,” the global description text of the reference image is obtained, and the object description text associated with the difference object is obtained. Finally, text expansion description is performed based on the global description text of the reference image, the object description text of the difference object, and the object relationship information between the difference object and the another object. Therefore, the difference information between the reference image and the similar image is fully described, to obtain an expanded difference description text. The difference description text abundantly expresses a relationship between the difference object and another object in the reference image and object state information of the difference object. In this way, compared with the object description text, the difference description text can more abundantly represent related information of the difference object in the reference image, so that the difference description text is subsequently used as a guiding condition when the similar image is adjusted, to accurately perform local fine adjustment on the similar image, and has reliability.

For example, when text expansion is performed on the difference information, an existing large language processing model may be used. Specifically, the object relationship information, the global description text, and the object description text of the difference object may be transmitted to the large language processing model, so that the large language processing model mines related information from the global description text and the object description text of the difference object based on the object relationship information, and further performs text expansion, to generate a text including abundant descriptions of the difference object, that is, the difference description text, to be used as data for subsequent image adjustment.

In the manner, a text for abundantly describing the difference information in the reference image may be obtained, so that the similar image is locally adjusted subsequently by using the difference description text as a guiding condition, to improve accuracy of image adjustment.

105: Locally adjust the similar image according to the target mask image, the difference description text, and the reference image, to obtain a target image.

In this embodiment of this application, to obtain the target image that better conforms to the content information in the reference image, after the similar image similar to the reference image is obtained, the similar image may be used as a to-be-adjusted image. Further, the target mask image, the difference description text, the reference image, and the like are used as guiding conditions for image processing, and the similar image is adjusted based on the guiding conditions, so that local fine adjustment is performed on the similar image, to generate the target image that better conforms to the content requirement of the reference image, which has reliability.

The target image may be an image that is not stored in the current database, and is mainly obtained by performing local fine adjustment based on the similar image. Specifically, after a similar image most similar to the reference image is found from the preset database, because the similar image may actually have a difference with the reference image, in this case, to obtain a similar image more matching the reference image, the similar image may be used as a basic image, and further fine adjustment is performed on the basic image according to the reference image, a target mask image for the difference, and a difference description text, to obtain a target image more similar to the reference image.

When a local area of the similar image is adjusted, the target mask image, the difference description text, and the reference image are mainly used as guiding conditions for image adjustment. A main function of target mask image is to affect presentation of pixels belonging to a target pixel area in the similar image. The target pixel area may be a pixel area corresponding to a difference or a non-difference between the reference image and the similar image. Adjustment of the similar image may include two parts. Specifically, a first part is to locally adjust the similar image with reference to the target mask image by using the difference description text as a guiding condition. A second part is to locally adjust the similar image with reference to the target mask image by using the reference image as a guiding (constraint) condition. For ease of understanding, adjustment of the similar image is specifically described below.

In this embodiment of this application, when local fine adjustment is performed on the similar image, mask processing may be first performed on the similar image, and then fine adjustment is performed on a mask processing result, to obtain the target image. In addition, an image may be masked in a fine adjustment process. The image fine adjustment process is not limited to be implemented in a noise processing manner. For a specific optional implementation, reference is made to the following descriptions.

(A) First perform mask processing on the similar image, and then perform fine adjustment on a mask processing result.

In some implementations, the difference description text and the reference image may be respectively used as guiding conditions for the similar image, and the similar image is locally adjusted separately, so that two adjustment results are fused to obtain the target image. For example, operation 105 may include:

(105.A.1): Perform local fine adjustment on the similar image according to the target mask image and the difference description text, to obtain a first image.

(105.A.2): Perform local fine adjustment on the similar image according to the target mask image and the reference image, to obtain a second image.

(105.A.3): Fuse the first image and the second image, to obtain the target image.

The first image may be an image obtained by locally adjusting the similar image according to the difference description text. Content in the image is different from that in the similar image. Some areas in the first image are blank pixel areas, that is, there is no content in the areas. Specifically, a pixel area corresponding to the difference information in the reference image is a blank pixel area. For example, it is assumed that content in a reference image and content in a similar image each include that a blue cat and an orange cat play on a lawn, but a difference between the two images is “a location of the blue cat in the image.” Therefore, when local fine adjustment is performed on the similar image according to a difference description text, a pixel area at the same location in the similar image may be adjusted according to a pixel area in which the blue cat is located in the reference image, and an adjusted pixel area is defined as a difference pixel area, to obtain a first image. The difference pixel area in the first image is replaced with a blank pixel area, that is, there is no content. In addition, when fine adjustment is performed on the similar image, a pixel area in which the original blue cat is located in the similar image may be further adjusted, so that a pixel area in which the blue cat is located in the original similar image in the first image is replaced with a blank pixel area. As another example, assuming that content included in a reference image and content included in a similar image each are that “A plate is provided with food and cutlery,” but a difference between the reference image and the similar image lies in a placement location of the cutlery, after the similar image is locally adjusted, a pixel area at the same location in the similar image is adjusted according to a pixel area in which the cutlery is located in the reference image, and an adjusted pixel area in an obtained first image is replaced with a blank pixel area.

The second image may be an image obtained by locally adjusting the similar image according to the guiding condition of the reference image. Most areas in the second image are blank pixel areas, only a pixel area corresponding to the difference information in the reference image is a non-blank pixel area, and content presented by a pixel combination in the non-blank pixel area is image content of the difference object corresponding to the difference information in the reference image. For example, it is assumed that content in a reference image and content in a similar image each include “A blue cat and an orange cat play on a lawn,” but a difference between the two images is “a location of the blue cat in the image.” Therefore, when local fine adjustment is performed on the similar image according to the reference image, a pixel area at the same location in the similar image may be adjusted according to a pixel area in which the blue cat is located in the reference image, a non-blank pixel area in an obtained second image includes the pixel area in which the blue cat is located in the reference image, and presented content is the blue cat in the reference image and information such as a shape, a posture, and an action of the blue cat. A middle part of the second image includes image content of the orange cat and the lawn. As another example, assuming that content included in a reference image and content included in a similar image each are “A plate is provided with food and cutlery,” but a difference between the reference image and the similar image lies in a placement location of the cutlery, after the similar image is locally adjusted, an obtained second image includes only image content of the cutlery in the reference image.

To obtain the target image more similar to the reference image, two stages of image adjustment and image fusion may be included. Specifically, in the image adjustment stage, two parts of difference description text guidance and reference image guidance may be included. A first part may be adjusting the similar image with reference to the target mask image by using the difference description text as the guiding condition for image adjustment, to obtain the first image, so that a pixel area corresponding to difference information in the first image is a blank pixel area and does not include image content. A second part may be adjusting the similar image with reference to the target mask image by using the reference image as the guiding condition for image adjustment, to obtain the second image, so that the second image includes only image content in a pixel area corresponding to difference information. Further, the obtained first image and second image are superposed and fused, so that the image content in the pixel area corresponding to the difference information in the second image and the blank pixel area corresponding to the difference information in the first image are superposed and filled, to implement image content complementation between the first image and the second image, so that a target image obtained through local fine adjustment is obtained. The target image better conforms to an image content requirement of the reference image, and is more similar to the reference image than the similar image.

Local fine adjustment may be performed on the similar image through a conditional latent diffusion (stable diffusion, SD) model. Specifically, a similar image is inputted into the conditional latent diffusion model, noise diffusion processing is performed on the similar image through the conditional latent diffusion model, and a guiding condition is introduced for assistance in a noise diffusion process, to indicate to perform accurate fine adjustment on a related pixel area in an image, to improve accuracy of image adjustment.

In some implementations, operation (105.A.1) may include: performing local fine adjustment on the similar image through a first neural network model based on the target mask image and the difference description text, to generate the first image. Operation (105.A.2) may include: performing local fine adjustment on the similar image through a second neural network model based on the target mask image and the reference image, to generate the second image. Both the first neural network model and the second neural network model are conditional latent diffusion (stable diffusion, SD) models.

In some implementations, to implement local fine adjustment on the similar image through the conditional latent diffusion (stable diffusion, SD) model, the conditional latent diffusion model needs to be trained, to separately obtain the first neural network model and the second neural network model for image fine adjustment.

For example, training of the first neural network model is used as an example. Before operation (105.A.1), the method may further include: obtaining a sample reference image, a sample similar image, and a first sample target image; generating a sample target mask image in the sample reference image and a sample difference description text based on difference information between the sample reference image and the sample similar image; performing local fine adjustment on the sample similar image through a preset model based on the sample target mask image and the sample difference description text, to generate a first prediction image; determining a prediction loss according to a difference between the first sample target image and the first prediction image; and performing iterative training on the preset model based on the prediction loss until a preset model convergence condition is reached, to obtain the first neural network model.

As another example, before operation (105.A.2), the method may further include: obtaining a sample reference image, a sample similar image, and a second sample target image; generating a sample target mask image of the sample reference image based on difference information between the sample reference image and a sample similar image, and obtaining a sample target inverse mask image opposite to the sample target mask image; performing local fine adjustment on the sample similar image through a preset model based on the sample target inverse mask image and the sample reference image, to generate a second prediction image; determining a prediction loss according to a difference between the second sample target image and the second prediction image; and performing iterative training on the preset model based on the prediction loss until a preset model convergence condition is reached, to obtain the second neural network model.

In some implementations, local fine adjustment of the similar image is mainly to introduce a guiding condition to noise diffusion of the image, to indicate, during noise diffusion, to perform local fine adjustment on a target area of the similar image, so as to improve accuracy of image adjustment. For example, an example in which the similar image is adjusted through the first neural network model by using the difference description text as the guiding condition for image adjustment is used. Operation (105.A.1) may include:

(105.A.1.1): Perform mask processing on the similar image according to the target mask image, to obtain a first similar mask image.

(105.A.1.2): Perform noise addition processing on the first similar mask image, to obtain a first similar noise image.

(105.A.1.3): Obtain a difference text vector corresponding to the difference description text.

(105.A.1.4): Perform noise reduction processing on the first similar noise image according to the difference text vector, to obtain a first feature image.

(105.A.1.5): Decode the first feature image, to obtain the first image.

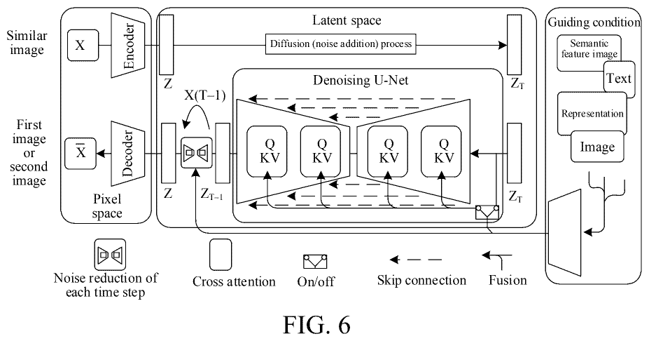

A function of the target mask image is to mask a target pixel area that is in the similar image and that is at the same location as an area in which the difference object is located in the reference image, to block a representation of a pixel in the target pixel area in the similar image. Therefore, before the similar image is adjusted through the first neural network model, mask processing may be first performed on the similar image according to the target mask image. The mask processing process may be multiplying the target mask image and the similar image, so that each value in the target mask image is multiplied by a corresponding pixel in the similar image, to obtain the first similar mask image. Then, the first similar mask image is inputted into the first neural network model, so that local fine adjustment is performed on the first similar mask image through the first neural network model. For ease of understanding, an image adjustment process of the first neural network model may be described with reference to FIG. 6. Specifically, the first neural network model encodes the first similar mask image, imports an encoding result into a latent space, and performs forward diffusion on the encoding result in the latent space, where the forward diffusion may be understood as a noise addition processing process, to obtain the first similar noise image. Then, before reverse diffusion is performed on the first similar noise image, text encoding is performed on the difference description text used as the guiding condition, to obtain the difference text vector, so that the difference description text is imported into the latent space. Further, reverse diffusion (noise reduction) processing is performed on the first similar noise image in the latent space, and during reverse diffusion processing, the difference text vector is fused into noise of the first similar noise image for reverse diffusion together, to obtain the first feature image. Finally, the first feature image is decoded, to restore the first feature image in the latent space, to obtain the first image.

Performing local fine adjustment on the first similar noise image through the first neural network model mainly includes two processes of forward diffusion and reverse diffusion. The forward diffusion is specifically a process of performing noise processing on an image, and may be understood as a process of gradual noise addition processing. The reverse diffusion process is a process of denoising a noise image, and may be understood as a gradual noise reduction process.

In some implementations, to perform forward diffusion on the similar image, the similar image needs to be converted into a vector to be imported into the latent space, and forward diffusion processing is performed in the latent space. For example, forward diffusion of a model using the difference description text as the guiding condition is used as an example. Operation (105.A.1.2) may include: encoding the first similar mask image to obtain an encoded feature image; and performing noise processing on the encoded feature image, to obtain the first similar noise image.

Specifically, after the first similar mask image is inputted into the first neural network model, the first neural network model performs image feature encoding on the first similar mask image in a pixel space, to obtain an encoded feature image, the encoded feature image being a vector feature matrix of the first similar mask image. Further, the encoded feature image is transmitted to a latent space, and forward diffusion is performed on the encoded feature image in the latent space. The forward diffusion process is a noise addition processing process, which is mainly to perform gradual noise addition processing on the encoded feature image, and after a plurality of time steps of noise addition processing are performed, complete noise processing is performed on the first similar mask image, to obtain a completely noised first similar noise image.

In some implementations, after the first similar noise image is obtained through forward noise addition processing, reverse noise reduction processing is performed on the first similar noise image, and a noise image after noise reduction is obtained with reference to a feature vector corresponding to the guiding condition in the noise reduction processing process. For example, an example in which the difference text vector corresponding to the difference description text is used as a guiding condition is used. Operation (105.A.1.4) may include: performing a plurality of consecutive times of denoising processing on the first similar noise image, and integrating, by using an attention mechanism, the difference text vector in each process of performing denoising processing on the first similar noise image, to obtain the first feature image, the first feature image including semantic information associated with the difference text vector.

Specifically, to perform reverse diffusion processing on the completely noised first similar noise image, noise reduction processing needs to be performed on the first similar noise image for a plurality of rounds (time steps), and the difference text vector corresponding to the difference description text is added in each noise reduction processing process, to implement accurate fine adjustment on the similar image until a preset quantity of time steps of noise reduction is performed, to obtain the first feature image.

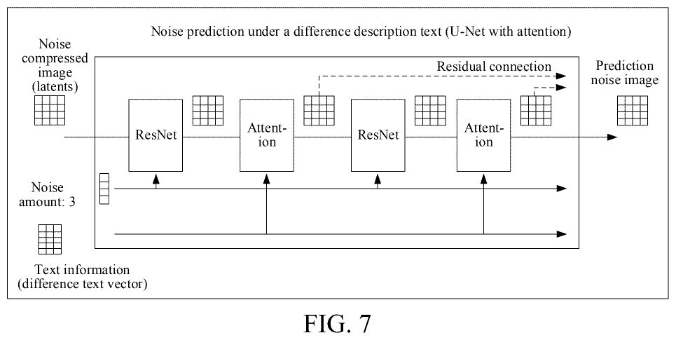

For example, for ease of understanding a noise reduction processing process of each round, a noise reduction processing process of a first round is used as an example. Because the first similar noise image is a completely noised noise image, assuming that T time steps of noise addition processing have been performed, the first similar noise image may be represented as “Z_{T}” or “X_{T}.” During noise reduction processing of the first round, noise reduction processing is performed on the first similar noise image “Z_{T},” and during the noise reduction processing, the difference text vector is integrated by using the attention mechanism. With reference to FIG. 6, a denoising processing process of each round is implemented in a denoising network layer (Denoising U-Net). Specifically, referring to FIG. 7, the denoising network layer (Denoising U-Net) includes a residual network layer (ResNet) and an attention module in terms of structure. The residual network layer (ResNet) is mainly configured to extract a feature, to implement a gradual noise reduction process. The attention module is configured to fuse a feature vector (for example, a text difference vector) corresponding to a guiding condition and a noise feature image, to implement indication and guidance for image fine adjustment.

Specifically, the noise reduction network layer (Denoising U-Net) may include two residual network layers and two attention modules, and is specifically “residual network layer-attention module-residual network layer-attention module” in terms of structure. The following describes a noise reduction processing process of one noise reduction round with reference to a specific result of the denoising network layer. Specifically, feature extraction is first performed on the first similar noise image through a 1^{st} residual network layer, a first feature result obtained through feature extraction is transmitted to a 1^{st} attention module, and a difference text vector is transmitted to the 1^{st} attention module. The difference text vector is fused with the first feature result through the 1^{st} attention module. For example, attention calculation may be performed on the difference text vector by using an attention mechanism, and an attention calculation result is fused with the first feature result, to obtain a first initial fusion result. Further, feature extraction is performed on the first initial fusion result through a 2^{nd} residual network layer, to obtain a second feature result, the second feature result is transmitted to a 2^{nd} attention module, the difference text vector is transmitted to the 2^{nd} attention module, and the difference text vector is fused with the second feature result through the 2^{nd} attention module, to obtain a first fused noise image.

According to the foregoing example, a plurality of rounds (“T−1” times) of noise reduction processing are performed, to obtain a final (T−1)^{th} fused noise image, the (T−1)^{th} fused noise image being the first feature image.

Further, after the first feature image is obtained, a decoding process of the first feature image may be specifically: decoding the first feature image in a latent space through a decoding module, to restore the first feature image into a pixel matrix in a pixel space, so that the first neural network model outputs the first image obtained through the local fine adjustment.

In some implementations, the similar image is adjusted through the second neural network model by using the reference image as the guiding condition for image adjustment. For example, operation (105.A.2) may include: performing negation on the target mask image, to obtain a target inverse mask image corresponding to the target mask image; performing mask processing on the similar image according to the target inverse mask image, to obtain a second similar mask image; performing noise addition processing on the second similar mask image to obtain a second similar noise image, a time step of the second similar noise image being adjacent to a time step of the first similar noise image; performing noise reduction processing on the second similar noise image according to a feature image corresponding to the reference image, to obtain a second feature image; and decoding the second feature image, to obtain the second image.

An objective of performing local fine adjustment on the similar image by using the reference image as the guiding condition is to obtain the second image including a representation of the difference object after image fine adjustment. Because a function of the target mask image is to mask the target pixel area that is in the similar image and that is the same as an area in which the difference object is located in the reference image, negation processing needs to be performed on the target mask image. The negation processing process is to replace original “0” in the target mask image with “1,” and replace original “1” in the target mask image with “0,” to obtain the target inverse mask image. A function of the target inverse mask image is to allow a representation of a pixel in the target pixel area in which the difference object is located and reject a representation of another pixel that is not in the target pixel area.

Further, after the target inverse mask image is obtained, mask processing is first performed on the similar image according to the target inverse mask image. The mask processing process may be multiplying the target inverse mask image and the similar image, so that each value in the target inverse mask image is multiplied by a corresponding pixel in the similar image, to obtain the second similar mask image. Then, the second similar mask image is inputted into the second neural network model, and local fine adjustment is performed on the second similar mask image through the second neural network model. For ease of understanding, an image adjustment process of the second neural network model may be described with reference to FIG. 6. Specifically, the second neural network model encodes the second similar mask image, imports an encoding result into a latent space, and performs forward diffusion on the encoding result in the latent space, where the forward diffusion may be understood as a noise addition processing process, to obtain the second similar noise image. Then, before reverse diffusion is performed on the second similar noise image, image encoding is performed on the reference image used as the guiding condition, to obtain a feature image (namely, a vector matrix) corresponding to the reference image, to import the feature image corresponding to the reference image into the latent space. Further, reverse diffusion processing is performed on the second similar noise image in the latent space, and during the reverse diffusion processing, the feature image corresponding to the reference image is fused into noise of the second similar noise image for reverse diffusion together, to obtain the second feature image. Finally, the second feature image is decoded, to restore the second feature image in the latent space to a pixel space for representation, so as to output the second image.

When the feature image of the reference image is used as a constraint condition, a specific processing process of performing reverse diffusion on the second similar noise image is the same as the foregoing operation of “performing the reverse diffusion processing process on the first similar noise image through the noise reduction network layer (Denoising U-Net).” Only the “feature image of the reference image” and the “difference text vector of the difference description text” that are different exist. For the reverse diffusion process, reference may be made to FIG. 6, FIG. 7 and the foregoing content for specific understanding. Details are not described herein again.

(B) Perform mask processing on an image in a fine adjustment processing process.

Local fine adjustment may be performed on the similar image through a conditional latent diffusion (stable diffusion, SD) model. Specifically, a similar image and a target mask image are inputted into the conditional latent diffusion model, noise diffusion processing is performed on the similar image through the conditional latent diffusion model, and guiding conditions (for example, a difference description text and a reference image) are introduced for assistance in a noise diffusion process, to indicate to perform accurate fine adjustment on a related pixel area in an image, to improve accuracy of image adjustment.

In some implementations, a plurality of consecutive time steps of noise processing are first performed on the similar image on which fine adjustment needs to be performed, two noise images whose time steps are adjacent are obtained, and fine adjustment is performed on the noise images according to the target mask image, the difference description text, and the reference image, so that fine-adjustment results are fused to obtain the target image. For example, operation 105 may include:

(105.B.1): Perform noise addition processing on the similar image, and obtain a first similar noise image and a second similar noise image that are of adjacent time steps in the noise addition processing.

(105.B.2): Perform denoising processing on the first similar noise image according to the target mask image and the difference description text, to obtain a first image.

(105.B.3): Perform denoising processing on the second similar noise image according to the target mask image and the reference image, to obtain a second image.

(105.B.4): Fuse the first image and the second image, to obtain the target image.

Specifically, local fine adjustment may be implemented on the similar image through the conditional latent diffusion (stable diffusion, SD) model. The similar image and the target mask image are transmitted to the diffusion model. The diffusion model encodes the similar image to obtain a feature image, and imports the feature image into a latent space for forward diffusion. The forward diffusion process is a gradual noise addition processing process for a plurality of time steps, and each time step is considered as one noise addition processing, until a completely noised noise image is obtained. Further, the completely noised noise image and a noise image of an adjacent previous time step may be obtained. Specifically, the noise image of the adjacent previous time step may be used as a first similar noise image, and the completely noised noise image may be used as a second similar noise image. Further, reverse diffusion processing is performed on the first similar noise image based on the target mask image and the difference description text, the reverse diffusion processing process being noise reduction processing for a plurality of consecutive times, to obtain a first image. Reverse diffusion processing is performed on the second similar noise image based on the target mask image and the reference image, to obtain a second image. Finally, the first image and the second image are fused, to obtain the target image.

For example, as shown in FIG. 6, a similar image X, a target mask image, a difference description text, and a reference image are transmitted to a conditional latent diffusion (stable diffusion, SD) model. The diffusion model encodes the similar image X, and imports an encoding result (a feature image Z) into a latent space. A completely noised noise image “Z_{T}” is obtained through forward diffusion (noise addition) processing, which is assumed as through T time steps of gradual noise addition processing, where the noise image may alternatively be represented as “X_{T}.” Therefore, the noise image “Z_{T}” is used as a second similar noise image, and a noise image “Z_{T-1}” whose time step is adjacent is used as a first similar noise image. Further, reverse diffusion processing is performed on the first similar noise image based on the target mask image and the difference description text, where the reverse diffusion is performing a corresponding quantity of time steps of noise reduction processing for example, performing “T−1” time steps of gradual noise reduction processing, and decoding is performed to obtain a first image. Similarly, reverse diffusion processing is performed on the second similar noise image. The reverse diffusion is performing a corresponding quantity of time steps of noise reduction processing, for example, performing “T−1” time steps of gradual noise reduction processing, to obtain a second feature image “Z,” and decoding is performed to obtain a second image. Finally, the first image and the second image are fused, and processing such as superimposition and stitching is performed, to obtain an adjusted target image.

A noise image whose time step is adjacent to that of the first similar noise image is selected as the second similar noise image, and the reference image is introduced in noise reduction for guiding noise reduction, so that it can be ensured that features of the reference image and the similar image are consistent at adjacent time steps “T−1” and “T.” For example, sizes are consistent, and reliability is achieved.

In some implementations, the first image is obtained by performing fine adjustment by using the difference description text as the guiding condition. For example, operation (105.B.2) may include: performing mask processing on the first similar noise image according to the target mask image, to obtain a first mask noise image; obtaining a difference text vector corresponding to the difference description text, and performing noise reduction processing on the first mask noise image according to the difference text vector, to obtain a first feature image; and decoding the first feature image, to obtain the first image.

For example, a conditional latent diffusion (stable diffusion, SD) model performs a plurality of times of noise addition processing to obtain the first similar noise image “Z_{T-1},” and the target mask image is multiplied by the first similar noise image to obtain a first mask noise image. In addition, text encoding is performed on the difference description text by using the difference description text as the guiding condition, to obtain a difference text vector. Further, gradual noise addition is performed on the first mask noise image based on the difference text vector. Specifically, in a noise reduction processing process of each time step, the difference text vector is introduced to noise of the time step by using an attention mechanism, and consecutive “T−1” time steps of noise reduction are continuously performed until noise is completely removed, to obtain a first feature image, for example, “Z” in FIG. 6. Finally, the first feature image is decoded, to obtain the first image. The foregoing is merely an example, and mask processing may alternatively be performed on the first feature image after complete denoising is performed. A time sequence of a mask processing process is specifically not limited herein.

In some implementations, the second image is obtained by performing fine adjustment by using the reference image as the guiding condition. Operation (105.B.3) may include: performing negation on the target mask image, to obtain a target inverse mask image corresponding to the target mask image, performing mask processing on the second similar noise image according to the target inverse mask image to obtain a second mask noise image; performing noise reduction processing on the second mask noise image according to a feature image corresponding to the reference image, to obtain a second feature image; and decoding the second feature image, to obtain the second image.

For example, after performing a plurality of times of noise addition processing to obtain the second similar noise image “Z_{T},” the conditional latent diffusion (stable diffusion, SD) model needs to perform mask processing on the second similar noise image. Because information about a difference object part needs to be extracted from the reference image, and information about other non-difference object parts in the reference image and the similar image needs to be masked, negation needs to be performed on the target mask image, to obtain a target inverse mask image opposite to the target mask image. Further, the target inverse mask image is multiplied by the second similar noise image to obtain a second mask noise image, and image encoding is performed on the reference image by using the reference image as the guiding condition, to obtain a feature image of the reference image. Further, gradual noise reduction is performed on the second mask noise image based on the feature image of the reference image. Specifically, in a noise reduction processing process of each time step, the feature image of the reference image is introduced to noise of the time step by using an attention mechanism, and consecutive “T” time steps of noise reduction are continuously performed until the noise is completely removed, to obtain a second feature image, for example, “Z” in FIG. 6. Finally, the second feature image is decoded, to obtain a second image. The foregoing is merely an example, and mask processing may alternatively be performed on the second feature image after complete denoising is performed. A time sequence of a mask processing process is specifically not limited herein.

In some implementations, a training process of the conditional latent diffusion (stable diffusion, SD) model is specifically as follows. A sample reference image, a sample similar image, and a sample target image are obtained, and a sample difference description text of the sample reference image relative to the sample similar image and a sample target mask image are obtained. Further, the sample reference image, the sample similar image, the sample difference description text, and the sample target mask image are transmitted to a preset SD model, and local fine adjustment is separately performed on the sample similar image with reference to the sample target mask image by using the sample difference description text and the sample reference image as guiding conditions, to obtain a prediction target image. Further, a difference between the prediction target image and the sample target image is obtained, to construct a prediction loss, and iterative training is performed on the preset SD model based on the prediction loss until a preset SD model convergence condition is reached, to obtain a trained target model, that is, the conditional latent diffusion model.

It can be learned from the foregoing that in this embodiment of this application, a similar image similar to a reference image may be first obtained from existing data; then a target mask image is generated based on difference information between the reference image and the similar image; the difference information is expanded to enrich a difference description text representing the difference information; and finally, local fine adjustment is performed on the existing similar image with reference to the target mask image, the difference description text, and the reference image, to obtain a target image obtained through fine adjustment. In this way, expansion description may be performed on a difference between images, and the similar image is locally adjusted by using an expanded description text for the difference and the reference image as constraints, to improve accuracy of image adjustment, so that an effect of an adjusted image conforms to an actual requirement, to facilitate subsequent development of another service.

According to the method described in the foregoing embodiments, the following further provides detailed descriptions by using examples.

In the embodiments of this application, image processing is used as an example to further describe the image processing method provided in this embodiment of this application.

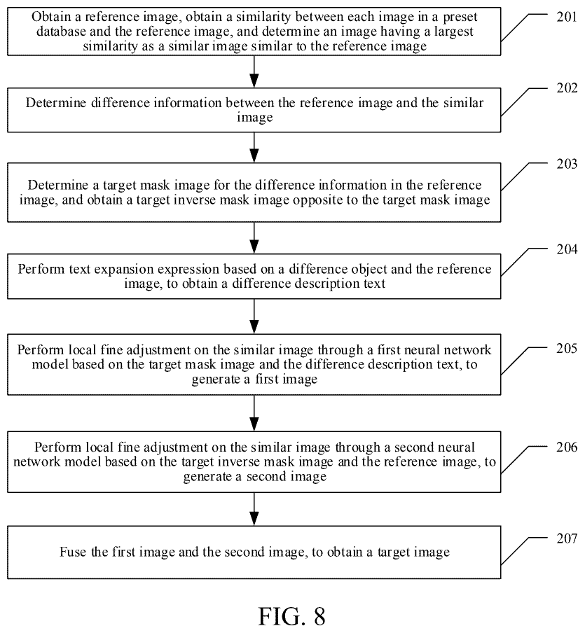

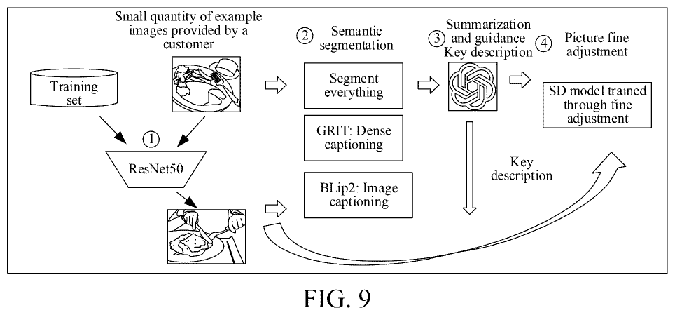

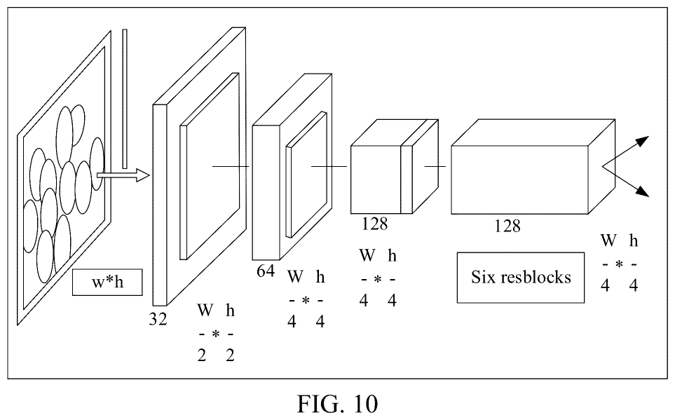

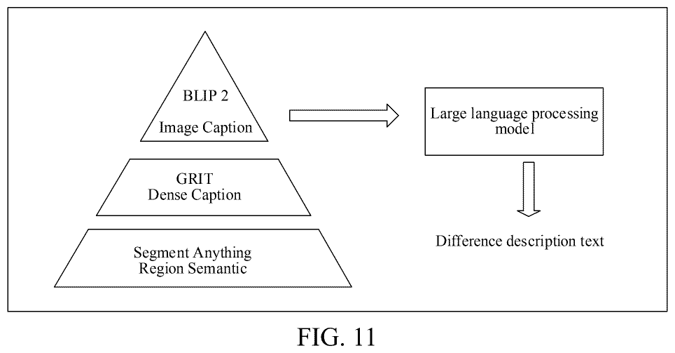

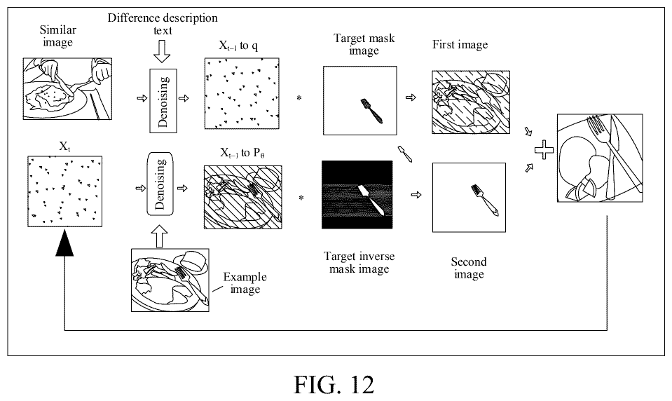

FIG. 8 is another schematic flowchart of operations of an image processing method according to an embodiment of this application. FIG. 9 is a schematic structural diagram of a framework of an image processing system according to an embodiment of this application. FIG. 10 is a schematic structural diagram of a residual network layer according to an embodiment of this application. FIG. 11 is a schematic diagram showing a scenario of aggregating difference information and generating a difference description text according to an embodiment of this application. FIG. 12 is a schematic diagram showing a scenario of an image fine adjustment process according to an embodiment of this application. For ease of understanding, descriptions are provided with reference to FIG. 3 to FIG. 12 in the embodiments of this application.

In the embodiments of this application, descriptions are provided from a perspective of an image processing apparatus. The image processing apparatus may be specifically integrated into a computer device such as a server. For example, when a processor on the computer device executes a program corresponding to the image processing method, a specific process of the image processing method is as follows.

201: Obtain a reference image, obtain a similarity between each image in a preset database and the reference image, and determine an image having a largest similarity as a similar image similar to the reference image.

In this embodiment of this application, to obtain a target image more similar to the reference image, a similar image most similar to the reference image may be found from the preset database, so that further image processing is subsequently performed on the found similar image. For example, local fine adjustment is performed on the similar image, to obtain the target image that is closer to the reference image.

The reference image may be an image including any content. For example, an image query service platform is used as an example. A customer sends one or more example images to the platform, where the example image is the reference image in this embodiment of this application. After receiving the example image, the platform may search an existing database for a similar image similar to the example image, so that the similar image is locally adjusted based on the similar image and with reference to a difference between the similar image and the reference image subsequently.

The similar image may be an image that is in the database and that is most similar to the reference image, and may be understood as an image that is in existing data and that is most similar to the reference image in terms of image content or image style.

Specifically, to select the similar image similar to the reference image from the preset database, a process of obtaining the similar image may be as follows. First, a reference cluster center corresponding to the reference image may be determined, and a feature category distance between the reference cluster center and each image cluster center in the existing database is calculated. Further, the similar image similar to the reference image may be selected according to the feature category distance. Specifically, it may be determined according to a value of the feature category distance that a cluster center of the reference image is closer to which image cluster center in the database, to determine an image category of a closer target image cluster center as an image category of the reference cluster center. Further, a feature distance between the reference image and each image of the image category of the target image cluster center is calculated. A value of the feature distance may reflect a similarity between any two images. Therefore, the similar image similar to the reference image may be selected according to the value of the feature distance. For example, an image having a smallest feature distance to the reference image is selected as the similar image.

202: Determine difference information between the reference image and the similar image.

The difference information may be information representing a feature difference between the reference image and the similar image, and includes but is not limited to difference information such as a quantity of objects (things) that differ in an image, an object location, and/or an object posture.

Specifically, to obtain the difference information between the reference image and the similar image, a first description text of the reference image and a second description text of the similar image may be obtained through image-to-text conversion. Further, the difference information between the reference image and the similar image is generated based on a difference between the first description text and the second description text.

For ease of understanding the first description text and the second description text, the first description text is used as an example for description. Specifically, the first description text may include a global description text of overall image content in the reference image and an object description text of each object in the image.

An approach for generating the global description text may be implemented based on a pre-trained frozen image encoder and a large language model (bootstrapping language-image pre-training with frozen image encoder and large language model, BLIP2). Specifically, the model may include two parts of vision-and-language representation learning and vision-to-language generative learning in terms of structure. The visual-and-language representation learning includes an image encoder and a lightweight querying transformer (Q-Former) in terms of structure. The vision-to-language generative learning includes a large language model (LLM) in terms of structure. A process of generating the global description text is as follows. The reference image is inputted into the image encoder, and the reference image is encoded through the image encoder, to obtain an image encoding result. Further, the image encoding result is inputted into the lightweight querying transformer, and an object category label in the reference image is determined, so that the image encoding result is fused with the object category label in the lightweight querying transformer, to obtain a fused feature result. Finally, the fused feature result is inputted into the large language model for language processing, to output a global description text of the reference image.

An approach for generating the object description text may be implemented based on a generative region-to-test transformer (GRIT). The model may include a visual encoder, a foreground object extractor for locating an object, and a text decoder in terms of structure. Specifically, a process of generating the object description text is as follows. Each object in a reference image is identified, so that a pixel area in which each object is located in the reference image is determined, and a category of each object is indicated. The reference image in which the pixel area and the category of each object have been determined is inputted into the generative image region-to-text transformer, so that region-to-language transformation is performed on the pixel area, to output a reference image obtained through transformation. The reference image obtained through transformation includes a marking box configured for marking each object and an object description text of an object in each marking box.

In this way, a difference situation between the reference image and the similar image can be determined, so that the similar image is subsequently adjusted by using the difference situation between the two images as an adjustment basis in an image processing process, to improve accuracy of image adjustment.

203: Determine a target mask image for the difference information in the reference image, and obtain a target inverse mask image opposite to the target mask image.

In this embodiment of this application, image processing is performed on the similar image mainly in a local adjustment manner. Therefore, a mask image for the difference information in the reference image needs to be obtained, so that local fine adjustment is performed on the similar image by using the mask image, to subsequently improve accuracy of image adjustment.

The target mask image may be a pixel area mask image generated for the difference information between the reference image and the similar image, and is configured for masking a target pixel area that is in the similar image and that is at the same location as an area in which the difference object is located in the reference image, to block a representation of a pixel in the target pixel area in the similar image, so that the target pixel area in the similar image is blank, that is, there is no content. The target mask image is mainly represented by “0” and “1.” A value in the target pixel area is “0,” and a value in an area other than the target pixel area is “1.”

In addition, the target inverse mask image is a mask image opposite to the target mask image, and is configured for allowing a representation of a pixel in a target pixel area in which the difference object is located and rejecting a representation of another pixel in a non-target pixel area. In the target inverse mask image, a value in the target pixel area is “1,” and a value in an area other than the target pixel area is “0.”

In this way, the target mask image for the difference object in the reference image and the target inverse mask image may be respectively obtained, so that local fine adjustment is separately performed on the similar image by using the target mask image and the target inverse mask image as needed elements when the similar image is adjusted, to subsequently improve accuracy of image adjustment.

204: Perform text expansion expression based on the difference object and the reference image, to obtain a difference description text.

In this embodiment of this application, a related description text of the difference information in the reference image further needs to be obtained, so that the related description text of the difference information is subsequently used as a guiding condition for image adjustment, to locally adjust the similar image, so as to improve accuracy of image adjustment.

The difference description text may be a text for describing a content difference between the reference image and the similar image, is mainly obtained by performing text expansion expression based on the difference information, and can abundantly and accurately represent a difference between the reference image and the similar image. The difference description text may be used as the guiding condition for adjusting the similar image, to participate in local adjustment on the similar image, to improve accuracy of image adjustment.

Specifically, to abundantly describe the difference information between the reference image and the similar image, first, a difference object corresponding to the difference information in the reference image may be determined, and object relationship information between the difference object and any other object in the reference image is obtained. For example, a current location relationship between the difference object and another object in the image is determined, or it is determined whether the difference object and the another object belong to the same object category. Further, with reference to obtaining of the “first description text,” the global description text of the reference image is obtained, and the object description text associated with the difference object is obtained. Finally, text expansion description is performed based on the global description text of the reference image, the object description text of the difference object, and the object relationship information between the difference object and the another object. Therefore, the difference information between the reference image and the similar image is fully described, to obtain an expanded difference description text. The difference description text abundantly expresses a relationship between the difference object and another object in the reference image and object state information of the difference object. In this way, compared with the object description text, the difference description text can more abundantly represent related information of the difference object in the reference image.

In the manner, a text for abundantly describing the difference information in the reference image may be obtained, so that the similar image is locally adjusted subsequently by using the difference description text as a guiding condition, to improve accuracy of image adjustment.

When a local area of the similar image is adjusted, the adjustment process includes two parts: first, locally adjusting the similar image with reference to the target mask image by using the difference description text as a guiding condition, to obtain a first image. For details, reference is made to the following operation 205; and second, locally adjusting the similar image with reference to the target inverse mask image by using the reference image as a guiding (constraint) condition, to obtain a second image. For details, reference is made to the following operation 206.

205: Perform local fine adjustment on the similar image through a first neural network model based on the target mask image and the difference description text, to generate a first image.

In this embodiment of this application, when local fine adjustment is performed on the similar image, the first neural network model may be a conditional latent diffusion (stable diffusion, SD) model. Specifically, a similar image is inputted into the conditional latent diffusion model, noise diffusion processing is performed on the similar image through the conditional latent diffusion model, and a guiding condition is introduced for assistance in a noise diffusion process, to indicate to perform accurate fine adjustment on a related pixel area in an image, to improve accuracy of image adjustment.

Specifically, before the similar image is adjusted through the latent diffusion model, mask processing is first performed on the similar image according to the target mask image. The mask processing process may be multiplying the target mask image and the similar image, so that each value in the target mask image is multiplied by a corresponding pixel in the similar image, to obtain a first similar mask image. Then, the first similar mask image is inputted into the latent diffusion model, and local fine adjustment is performed on the first similar mask image through the latent diffusion model. For ease of understanding, an image adjustment process of the latent diffusion model may be described with reference to FIG. 6 and FIG. 7. Specifically, the latent diffusion model encodes the first similar mask image, imports an encoding result (a first encoded feature image) into a latent space, and performs forward diffusion on the encoding result in the latent space, where the forward diffusion may be understood as a gradual noise addition processing process for a plurality of time steps, to obtain a completely noised first similar noise image. Then, before reverse diffusion is performed on the first similar noise image, text encoding is performed on the difference description text used as the guiding condition, to obtain a difference text vector, so that the difference description text is imported into the latent space. Further, in the latent space, reverse diffusion processing is performed on the first similar noise image through a noise reduction network layer (Denoising U-Net). The reverse diffusion processing may be understood as performing a plurality of times (a plurality of time steps) of noise reduction processing. Feature extraction is performed on a noise image of a current time step through a residual network layer (ResNet) in each noise reduction processing process, and a difference text vector is integrated by using an attention mechanism. A plurality of time steps of noise reduction processing are performed, to obtain a first feature image. Finally, the first feature image is decoded, to restore the first feature image in the latent space to a pixel space for pixel representation, to obtain a first image.

There is a difference between the similar image and the first image obtained through local adjustment according to the difference description text. Specifically, a pixel area that is in the first image and that corresponds to the difference object in the reference image is a blank pixel area, that is, there is no image content.

206: Perform local fine adjustment on the similar image through a second neural network model based on the target inverse mask image and the reference image, to generate a second image.

Specifically, first, the target inverse mask image and the similar image are multiplied, so that each value in the target inverse mask image is multiplied by a corresponding pixel in the similar image, to obtain a second similar mask image. Then, the second similar mask image is inputted into the second neural network model, and the second similar mask image is encoded in a pixel space, to obtain a second encoded feature image. Next, the second encoded feature image is imported into a latent space, and a plurality of time steps of gradual noise addition processing are performed on the second encoded feature image in the latent space, to obtain a completely noised second similar noise image. Further, image encoding is performed on the reference image used as the guiding condition, to obtain a feature image (namely, a vector matrix) corresponding to the reference image. A plurality of time steps of noise reduction processing are performed on the second similar noise image in the latent space. The feature image of the reference image is integrated for a plurality of times with reference to an attention mechanism in each time step of noise reduction processing process. A plurality of time steps of noise reduction processing are performed, to obtain a second feature image. Finally, the second feature image is decoded. Specifically, the second feature image in the latent space is restored to the pixel space for pixel representation, to obtain a second image.

There is a difference between the similar image and the second image obtained through local adjustment according to the reference image. Specifically, a pixel area that is in the second image and that corresponds to non-difference information in the reference image is a blank pixel area, and a pixel area corresponding to the difference information is not the blank pixel area, that is, the second image includes only image content of the pixel area corresponding to the difference information.

For training processes of the first neural network model and the second neural network model, reference may be made to the descriptions in the foregoing embodiments. Details are not described herein again.

207: Fuse the first image and the second image, to obtain a target image.

In this embodiment of this application, after the first image obtained through adjustment by using the difference description text as the guiding condition and the second image obtained through adjustment by using the reference image as the guiding condition are obtained, the obtained first image and second image are superposed and fused, so that image content of the pixel area that corresponds to the difference information and that is in the second image and the blank pixel area that corresponds to the difference information and that is in the first image are superposed and filled, to implement image content complementation between the first image and the second image, so as to obtain a target image obtained through local fine adjustment. The target image better conforms to an image content requirement of the reference image, and is more similar to the reference image than the similar image, so that reliability is achieved.

In some implementations, operation 205 and operation 206 may be further implemented by using the following process. Specifically, local fine adjustment may be implemented on the similar image through the conditional latent diffusion (stable diffusion, SD) model. The similar image and the target mask image are transmitted to the diffusion model. The diffusion model encodes the similar image to obtain a feature image, and imports the feature image into a latent space for forward diffusion. The forward diffusion process is a gradual noise addition processing process for a plurality of time steps, and each time step is considered as one noise addition processing, until a completely noised noise image is obtained. Further, the completely noised noise image and a noise image of an adjacent previous time step may be obtained. Specifically, the noise image of the adjacent previous time step may be used as a first similar noise image, and the completely noised noise image may be used as a second similar noise image. Further, reverse diffusion processing is performed on the first similar noise image based on the target mask image and the difference description text, the reverse diffusion processing process being noise reduction processing for a plurality of consecutive times, to obtain a first image. Reverse diffusion processing is performed on the second similar noise image based on the target mask image and the reference image, to obtain a second image. Finally, the first image and the second image are fused, to obtain the target image. For descriptions of the implementation, reference may be made to the descriptions in the foregoing embodiment (B). Details are not described herein again.

For ease of understanding the embodiments of this application, the embodiments of this application are described by using specific application scenario examples. Specifically, the application scenario examples are described by performing the foregoing operation 201 to operation 207 and with reference to FIG. 3 to FIG. 12.

Specifically, the image processing method is mainly applied to an image local fine adjustment scenario, and an image processing scenario example is specifically as follows.

1. With reference to FIG. 9, the image processing system may include: in terms of framework, a training set (a preset database), a residual network feature extraction layer (ResNet50), a semantic segmentation layer (Segment everything, GRIT, and BLip2), a large language processing model, and a latent diffusion (SD) model trained through fine adjustment.

For ease of understanding, an image processing process is summarized with reference to processing layers in FIG. 9. Specifically,

(1) A similar image similar to an example image is obtained from the training set (a currently stored image set), where the similar image is a picture that is highly similar to the example image but whose key local information (a difference object) may be different from the example image or missing. A process of obtaining the similar image may be implemented through the residual network feature extraction layer (ResNet50).

With reference to FIG. 10, as a backbone network (a basic network), the ResNet50 includes an encoder in terms of structure. The program is a convolutional neural network (CNN). A feature extraction module of the convolutional neural network (CNN) includes three convolutional layers and six resblocks. For an inputted image (for example, a reference image), after the three convolutional layers, a width (w) and a height (h) of the image are ¼ of an original width and height of the image, a quantity of channels changes from 3 to 128, and a feature image of w/4*h/4*128 is formed. The feature image passes through a sub-network including the six resblocks, to generate a new high-layer semantic feature image. Each resblock includes two convolution layers and one pass-through (identity) layer in terms of structure. After the six resblocks, the obtained high-layer semantic feature image is w*h*c (for example, w/64*h/64*1024).

Specifically, first, an example image provided by a customer is inputted to the residual network feature extraction layer (ResNet50), to obtain a high-layer semantic feature image of a reference image, and a feature mean value of the reference image is obtained based on high-layer semantic information. Similarly, image data in the training set is traversed in the foregoing manner, to obtain a high-layer semantic feature image of each image in the training set, and a feature mean value of each image is obtained. Then, feature dimensions of the high-layer semantic feature image of the reference image and the high-layer semantic feature image of each image in the training set are reduced. For example, a dimension of a feature image is reduced to 128 dimensions through global maximum pooling.

Further, an image cluster center Ac of each category in the training set and a cluster center Bc of the example image are calculated, and a similarity between the example image and each category in the training set is calculated by using the cluster centers. A specific formula is as follows:

$$similarity ( A , B ) = \frac{A * B}{‖ A ‖ ‖ B ‖} = \frac{{\sum }_{i = 1}^{n} {A}_{i} {B}_{i}}{\sqrt{{\sum }_{i = 1}^{n} {A}_{i}^{2}} \sqrt{{\sum }_{i = 1}^{n} {B}_{i}^{2}}}$$

Finally, for each example image, it is determined whether a similarity “pred(B)*similarity(Ac, B)” between each example image and the image cluster center Ac of each category in the training set is greater than the similarity between the cluster center of the example image provided by the customer and the image cluster center of each category in the training set. Therefore, an image whose similarity is greater than the similarity is used as a similar image, to facilitate subsequent adjustment.

(2) Respectively obtain semantic information of the example image (the reference image) and semantic information of the similar image, to determine difference information between the two images.

A global description text of the reference image is obtained through a pre-trained frozen image encoder and a large language model (bootstrapping language-image pre-training with frozen image encoder and large language model, BLIP2). Similarly, a global description text of the similar image is obtained.

An object description text of each object in the reference image is obtained through a generative region-to-text transformer (GRIT). Similarly, an object description text of each object in the similar image is obtained.

Further, the difference information between the reference image and the similar image may be determined according to a difference between the global description texts of the reference image and the similar image and a difference between the object description texts in the reference image and the similar image.

In addition, a target mask image corresponding to an object for the difference information is obtained through a mask segmentation (segment everything) model.

(3) With reference to FIG. 11, the difference information is imported to a large language processing model for aggregation processing, and the model is guided to generate a key description (namely, a difference description text) for the difference information. Specifically, the large language processing model infers a relationship between objects (objects in images) in the images and information about the objects, to obtain a high-quality text for a difference object, that is, the difference description text. The large language processing model may be any type of language processing model, for example, “Chat-Gpt.” This is not limited herein.

(4) Perform local fine adjustment on the similar image, which mainly includes two parts. Specifically, first, local fine adjustment is performed on the similar image by using the difference description text as prompt information (prompt). Second, local fine adjustment is performed on the similar image by using the reference image as prompt information (prompt). The image fine adjustment is specifically described as follows.

FIG. 12 is a schematic diagram showing a scenario of an image fine adjustment process. Specifically, an objective of image fine adjustment is to use a similar image as an upper input image, and adjust, based on an example image provided by a customer, the similar image to a target image more similar to the example image. As shown in the figure, in the target image, a hand of a person is not included, and knife and fork are placed on a dinner dish. This is more similar to the example image.

First, the similar image is inputted into an upper layer, and noise diffusion processing is performed. A difference description text is introduced during diffusion (for example, denoising or noise reduction) as prompt information (prompt). The prompt information may be understood as a guiding condition. During noise diffusion, a noise diffusion image (which is defined as a first noise image) of one time step may be randomly selected, the noise diffusion image and a target mask image (mask) are combined, and an initial image, namely, a first image, related to the example image is obtained through reverse diffusion. An upper diffusion process may be represented as follows.

$${x}_{t - 1}^{train} ∼ N ( \sqrt{\overline{{a}_{t}}} {x}_{0} , ( 1 - \overline{{a}_{t}} ) I )$$

Then, lower noise diffusion is performed on the similar image in the manner of the upper layer. A noise diffusion image (which is defined as a second noise image) of a next time step relative to the upper noise diffusion image is selected. The example image (the reference image) is used as a constraint condition during noise reduction diffusion, the second noise image and an inverse mask image of the target mask image (mask) are combined, and denoising is performed to obtain a second image. Two noise images whose time steps are adjacent may be selected as the first noise image and the second noise image respectively, to ensure consistency between a feature of the first image obtained in the upper layer and a feature of the second image obtained in the lower layer. For example, image sizes are consistent, so that the first image and the second image can be accurately fused subsequently. A lower diffusion process may be represented as follows.

$${x}_{t - 1}^{cus} ∼ N ( {μ}_{θ} ( {x}_{t} , t ) , {\sum }_{θ} ( {x}_{t} , t ) )$$

Finally, the first image and the second image are fused, to obtain a target image. The image fusion process may be represented as follows:

$${x}_{t - 1} = m ⊙ {x}_{t - 1}^{train} + ( 1 - m ) ⊙ {x}_{t - 1}^{cus}$$

The scenario operations (1) to (4) are performed, and the following may be implemented: a picture relatively similar to data of a customer is found from the training set, then an example image of the customer is separately inputted into a plurality of large models (segment everything, blip2, grit, and the like), and corresponding prompts (picture descriptions) are outputted. Then, description words are described through chatgpt, and the chatgpt is guided to add details to key features that are identified artificially, so as to obtain a final description word. Finally, a difference between the similar image and the example image provided by the customer is emphatically smeared by using an SD model, so that the image is locally regenerated, to obtain a target image.

According to the foregoing application scenario example, the following effects can be achieved: the difference between the example image and the similar image is used as a guiding condition, and local fine adjustment is performed on a small quantity of images provided by the customer, to improve accuracy of image fine adjustment, so as to obtain a target image that better conforms to the example image.

It can be learned from the foregoing that in this embodiment of this application, a similar image similar to a reference image may be first obtained from existing data; then a target mask image is generated based on difference information between the reference image and the similar image; the difference information is expanded to enrich a difference description text representing the difference information; and finally, local fine adjustment is performed on the existing similar image with reference to the target mask image, the difference description text, and the reference image, to obtain a target image obtained through fine adjustment. In this way, expansion description may be performed on a difference between images, and the similar image is locally adjusted by using an expanded description text for the difference and the reference image as constraints, to improve accuracy of image adjustment, so that an effect of an adjusted image conforms to an actual requirement, to facilitate subsequent development of another service.

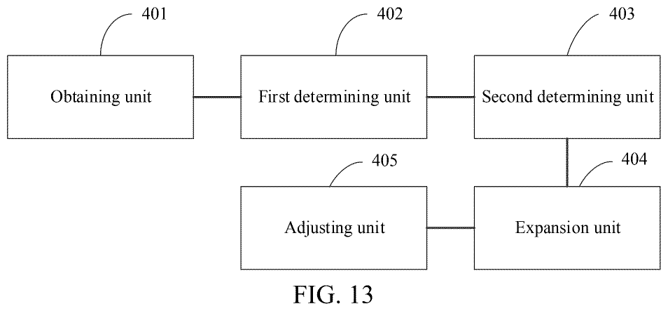

To better implement the foregoing methods, an embodiment of this application further provides an image processing apparatus. For example, as shown in FIG. 13, the image processing apparatus may include an obtaining unit 401, a first determining unit 402, a second determining unit 403, an expansion unit 404, and an adjusting unit 405.

The obtaining unit 401 is configured to obtain a reference image, obtain a similarity between each image in a preset database and the reference image, and determine an image having a largest similarity as a similar image similar to the reference image.

The first determining unit 402 is configured to determine difference information between the reference image and the similar image.

The second determining unit 403 is configured to determine a target mask image for the difference information in the reference image, the target mask image being configured for highlighting a difference object that is in the reference image relative to the similar image and that is determined according to the difference information.

The expansion unit 404 is configured to perform text expansion expression based on the difference object and the reference image, to obtain a difference description text, the difference description text being a text configured for describing a content difference between the reference image and the similar image.

The adjusting unit 405 is configured to locally adjust the similar image according to the target mask image, the difference description text, and the reference image, to obtain a target image, the target image being an image conforming to a content requirement of the reference image.

In some implementations, the adjusting unit 405 is further configured to: perform noise addition processing on the similar image, and obtain a first similar noise image and a second similar noise image that are of adjacent time steps in the noise addition processing; perform denoising processing on the first similar noise image according to the target mask image and the difference description text, to obtain a first image; perform denoising processing on the second similar noise image according to the target mask image and the reference image, to obtain a second image; and fuse the first image and the second image, to obtain the target image.

In some implementations, the adjusting unit 405 is further configured to: perform mask processing on the first similar noise image according to the target mask image, to obtain a first mask noise image; obtain a difference text vector corresponding to the difference description text, and perform noise reduction processing on the first similar noise image according to the difference text vector, to obtain a first feature image; and decode the first feature image, to obtain the first image.

In some implementations, the adjusting unit 405 is further configured to: perform negation on the target mask image, to obtain a target inverse mask image corresponding to the target mask image; perform mask processing on the second similar noise image according to the target inverse mask image to obtain a second mask noise image; perform noise reduction processing on the second mask noise image according to a feature image corresponding to the reference image, to obtain a second feature image; and decode the second feature image, to obtain the second image.

In some implementations, the adjusting unit 405 is further configured to: perform local fine adjustment on the similar image according to the target mask image and the difference description text, to obtain a first image; perform local fine adjustment on the similar image according to the target mask image and the reference image, to obtain a second image; and fuse the first image and the second image, to obtain the target image.

In some implementations, the adjusting unit 405 is further configured to: perform mask processing on the similar image according to the target mask image, to obtain a first similar mask image; perform noise addition processing on the first similar mask image, to obtain a first similar noise image; obtain a difference text vector corresponding to the difference description text; perform noise reduction processing on the first similar noise image according to the difference text vector, to obtain a first feature image; and decode the first feature image, to obtain the first image.

In some implementations, the noise reduction processing is denoising processing for a plurality of consecutive times; and the adjusting unit 405 is further configured to: integrate, by using an attention mechanism, the difference text vector in each process of performing denoising processing on the first similar noise image, to obtain the first feature image, the first feature image including semantic information associated with the difference text vector.

In some implementations, the adjusting unit 405 is further configured to: encode the first similar mask image to obtain an encoded feature image; and perform noise processing on the encoded feature image, to obtain the first similar noise image.

In some implementations, the adjusting unit 405 is further configured to: perform local fine adjustment on the similar image through a first neural network model based on the target mask image and the difference description text, to generate the first image; and
the image processing apparatus further includes a training unit, configured to: obtain a sample reference image, a sample similar image, and a first sample target image; generate a sample target mask image in the sample reference image and a sample difference description text based on difference information between the sample reference image and the sample similar image; perform local fine adjustment on the sample similar image through a preset model based on the sample target mask image and the sample difference description text, to generate a first prediction image; determine a prediction loss according to the first sample target image and the first prediction image; and perform iterative training on the preset model based on the prediction loss until a preset model convergence condition is reached, to obtain the first neural network model.

In some implementations, the adjusting unit 405 is further configured to: perform negation on the target mask image, to obtain a target inverse mask image corresponding to the target mask image; perform mask processing on the similar image according to the target inverse mask image, to obtain a second similar mask image; performing noise addition processing on the second similar mask image to obtain a second similar noise image; perform noise reduction processing on the second similar noise image according to a feature image corresponding to the reference image, to obtain a second feature image; and decode the second feature image, to obtain the second image.

In some implementations, the expansion unit 404 is further configured to: determine the difference object in the reference image relative to the similar image according to the difference information; determine object relationship information between the difference object and each object in the reference image; obtain a global description text of the reference image and a target object description text of the difference object; and perform text expansion based on the global description text, the target object description text, and the object relationship information, to obtain the difference description text.

In some implementations, the obtaining unit 401 is further configured to: determine a reference cluster center to which the reference image belongs; determine a feature category distance between each preconstructed image cluster center in the preset database and the reference cluster center; and determine, based on the feature category distance, a similarity between an image corresponding to each image cluster center and the reference image, and determine an image having a largest similarity as the similar image similar to the reference image.

In some implementations, the first determining unit 402 is further configured to: obtain a first description text corresponding to the reference image; obtain a second description text corresponding to the similar image; and generate the difference information based on a difference between the first description text and the second description text.

In some implementations, the first determining unit 402 is further configured to: perform global description on the reference image through a first preset model, to generate a global description text of the reference image; process, through a second preset model, a pixel area in which each object is located in the reference image, to obtain an object description text corresponding to each object in the reference image; and determine the first description text corresponding to the reference image according to the global description text of the reference image and the object description text corresponding to each object.

In some implementations, the second determining unit 403 is further configured to: determine the difference object in the reference image relative to the similar image according to the difference information; and generate the target mask image based on the difference object in the reference image.

It can be learned from the foregoing that in this embodiment of this application, a similar image similar to a reference image may be first obtained from existing data; then a target mask image is generated based on difference information between the reference image and the similar image; the difference information is expanded to enrich a difference description text representing the difference information; and finally, local fine adjustment is performed on the existing similar image with reference to the target mask image, the difference description text, and the reference image, to obtain a target image obtained through fine adjustment. In this way, expansion description may be performed a difference between images, and the similar image is locally adjusted by using an expanded description text for the difference and the reference image as constraint conditions, to improve accuracy of image adjustment, so that an effect of an adjusted image conforms to an actual requirement, to facilitate subsequent development of another service.

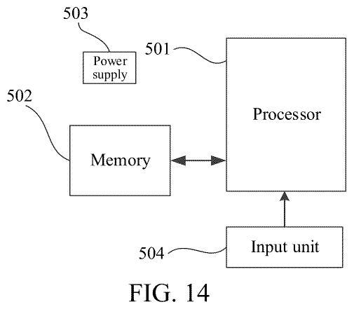

An embodiment of this application further provides a computer device. FIG. 14 is a schematic structural diagram of a computer device according to an embodiment of this application. Specifically,
the computer device may include components such as a processor 501 including one or more processing cores, a memory 502 including one or more computer-readable storage media, a power supply 503, and an input unit 504. A person skilled in the art may understand that, the structure of the computer device shown in FIG. 14 does not constitute a limitation to the computer device. The computer device may include components that are more or fewer than those shown in the figure, or some components may be combined, or a different component deployment may be used.

The processor 501 is a control center of the computer device, is connected to all parts of the entire computer device by using various interfaces and lines, and executes various functions of the computer device and performs data processing by running or executing a software program and/or a module stored in the memory 502 and calling data stored in the memory 502. In some embodiments, the processor 501 may include one or more processing cores. In some embodiments, the processor 501 may be an integration of an application processor and a modem processor. The application processor mainly processes an operating system, a user interface, an application program, and the like. The modem processor mainly processes wireless communication. The above modem processor may alternatively not be integrated into the processor 501.

The memory 502 may be configured to store a software program and a module. The processor 501 runs the software program and the module that are stored in the memory 502, to perform various functional applications and image processing processes. The memory 502 may mainly include a program storage area and a data storage area. The program storage area may store an operating system, an application program required by at least one function (for example, a sound playback function and an image display function), and the like. The data storage area may store data created according to use of the computer device. In addition, the memory 502 may include a high-speed random access memory, and may further include a non-volatile memory such as at least one magnetic disk storage device or a flash memory device, or another volatile solid storage device. Correspondingly, the memory 502 may further include a memory controller, to allow the processor 501 to access the memory 502.

The computer device further includes the power supply 503 supplying power to the components. In some embodiments, the power supply 503 may be logically connected to the processor 501 by a power management system, thereby implementing functions such as charging, discharging, and power consumption management by using the power management system. The power supply 503 may further include one or more of a direct current or alternating current power supply, a re-charging system, a power failure detection circuit, a power supply converter or inverter, a power supply state indicator, and any other component.

The computer device may further include the input unit 504. The input unit 504 may be configured to receive input digit or character information and generate keyboard, mouse, joystick, optical, or trackball signal input related to user settings and function control.

Although not shown in the figure, the computer device may further include a display unit, and the like. Details are not described herein again. Specifically, in this embodiment of this application, the processor 501 in the computer device may load executable files corresponding to processes of one or more application programs to the memory 502 according to the following instructions, and the processor 501 runs the application programs stored in the memory 502, to implement various functions:
obtaining a reference image, obtaining a similarity between each image in a preset database and the reference image, and determining an image having a largest similarity as a similar image similar to the reference image; determining difference information between the reference image and the similar image; determining a target mask image for the difference information in the reference image, the target mask image being configured for highlighting a difference object that is in the reference image relative to the similar image and that is determined according to the difference information; performing text expansion expression based on the difference object and the reference image, to obtain a difference description text, the difference description text being a text configured for describing a content difference between the reference image and the similar image; and locally adjusting the similar image according to the target mask image, the difference description text, and the reference image, to obtain a target image, the target image being an image conforming to a content requirement of the reference image.

For a specific implementation of each of the foregoing operations, reference may be made to the foregoing embodiments. Details are not described herein again.

It can be learned from the foregoing that in this solution, a similar image similar to a reference image may be first obtained from existing data; then a target mask image is generated based on difference information between the reference image and the similar image; the difference information is expanded to enrich a difference description text representing the difference information; and finally, local fine adjustment is performed on the existing similar image with reference to the target mask image, the difference description text, and the reference image, to obtain a target image obtained through fine adjustment. In this way, expansion description may be performed on a difference between images, and the similar image is locally adjusted by using an expanded description text for the difference and the reference image as constraints, to improve accuracy of image adjustment, so that an effect of an adjusted image conforms to an actual requirement, to facilitate subsequent development of another service.

A person of ordinary skill in the art may understand that, all or some steps of the methods in the foregoing embodiments may be implemented by using instructions, or implemented through instructions controlling relevant hardware, and the instructions may be stored in a computer-readable storage medium and loaded and executed by a processor.

Accordingly, an embodiment of this application provides a computer-readable storage medium, storing a plurality of instructions. The instructions can be loaded by a processor, to perform the operations in the image processing method according to the embodiments of this application. For example, the instructions may perform the following operations:
obtaining a reference image, and obtaining a similar image similar to the reference image; determining difference information between the reference image and the similar image; determining a target mask image for the difference information in the reference image, performing expansion based on the difference information, to obtain a difference description text; and locally adjusting the similar image according to the target mask image, the difference description text, and the reference image to obtain a target image.

For specific implementations of each of the foregoing operations, reference may be made to the foregoing embodiments. Details are not described herein again.

The computer-readable storage medium may include: a read-only memory (ROM), a random access memory (RAM), a magnetic disk, an optical disc or the like.

Since the instructions stored in the computer-readable storage medium may perform the operations of any image processing method provided in the embodiments of this application, the computer program can implement advantageous effects that may be implemented by any image processing method provided in the embodiments of this application. The foregoing embodiments may be referred to for details. Details are not described herein.

According to an aspect of this application, a computer program product is provided, the computer program product or a computer program including computer instructions, the computer instructions being stored in a computer-readable storage medium. A processor of a computer device reads the computer instructions from the computer-readable storage medium, and executes the computer instructions, so that the computer device performs the method provided in the various optional implementations provided in the foregoing embodiments.

The image processing method and apparatus, the device, and the computer-readable storage medium provided in the embodiments of this application are described in detail above. The principles and implementations of this application are described through specific examples in this specification, and the descriptions of the embodiments are only intended to help understand the methods and core ideas of this application. In addition, a person skilled in the art may make modifications to the specific implementations and the application scope based on the idea of this application. In summary, the content of this specification is not to be construed as a limitation on this application.

What is claimed is:

1. An image processing method comprising:
obtaining a similarity between each image in a database and a reference image, and determining an image having a largest similarity in the database as a similar image;
determining difference information between the reference image and the similar image;
determining a target mask image, in the reference image, for the difference information, the target mask image highlighting a difference object that is in the reference image relative to the similar image and that is determined according to the difference information;
performing text expansion expression based on the difference object and the reference image, to obtain a difference description text, the difference description text describing a content difference between the reference image and the similar image; and
locally adjusting the similar image according to the target mask image, the difference description text, and the reference image, to obtain a target image conforming to a content requirement of the reference image.

2. The method according to claim 1, wherein locally adjusting the similar image includes:
performing noise addition processing on the similar image, and obtaining a first similar noise image and a second similar noise image that are of adjacent time steps in the noise addition processing;
performing denoising processing on the first similar noise image according to the target mask image and the difference description text, to obtain a first image;
performing denoising processing on the second similar noise image according to the target mask image and the reference image, to obtain a second image; and
fusing the first image and the second image, to obtain the target image.

3. The method according to claim 2, wherein performing denoising processing on the first similar noise image includes:
performing mask processing on the first similar noise image according to the target mask image, to obtain a mask noise image;
obtaining a difference text vector corresponding to the difference description text;
performing noise reduction processing on the mask noise image according to the difference text vector, to obtain a feature image; and
decoding the feature image, to obtain the first image.

4. The method according to claim 2, wherein performing denoising processing on the second similar noise image includes:
performing negation on the target mask image, to obtain a target inverse mask image corresponding to the target mask image;
performing mask processing on the second similar noise image according to the target inverse mask image to obtain a mask noise image;
performing noise reduction processing on the mask noise image according to a feature image corresponding to the reference image, to obtain a feature image corresponding to the mask noise image; and
decoding the feature image corresponding to the mask noise image, to obtain the second image.

5. The method according to claim 1, wherein locally adjusting the similar image includes:
performing local fine adjustment on the similar image according to the target mask image and the difference description text, to obtain a first image;
performing local fine adjustment on the similar image according to the target mask image and the reference image, to obtain a second image; and
fusing the first image and the second image, to obtain the target image.

6. The method according to claim 5, wherein performing local fine adjustment on the similar image according to the target mask image and the difference description text includes:
performing mask processing on the similar image according to the target mask image, to obtain a similar mask image;
performing noise addition processing on the similar mask image, to obtain a similar noise image;
obtaining a difference text vector corresponding to the difference description text;
performing noise reduction processing on the similar noise image according to the difference text vector, to obtain a feature image; and
decoding the feature image, to obtain the first image.

7. The method according to claim 6, wherein:
the noise reduction processing includes denoising processing for a plurality of consecutive times; and
performing noise reduction processing on the similar noise image includes:
integrating, through an attention mechanism, the difference text vector in each process of performing denoising processing on the similar noise image, to obtain the feature image, the feature image including semantic information associated with the difference text vector.

8. The method according to claim 6, wherein performing noise addition processing on the similar mask image includes:
encoding the similar mask image to obtain an encoded feature image; and
performing noise processing on the encoded feature image, to obtain the similar noise image.

9. The method according to claim 5,
wherein performing local fine adjustment on the similar image according to the target mask image and the difference description text includes:
performing local fine adjustment on the similar image through a neural network model based on the target mask image and the difference description text, to generate the first image;
the method further comprising, before performing local fine adjustment on the similar image through the neural network model:
obtaining a sample reference image, a sample similar image, and a sample target image;
generating a sample target mask image in the sample reference image and a sample difference description text based on difference information between the sample reference image and the sample similar image;
performing local fine adjustment on the sample similar image through a model based on the sample target mask image and the sample difference description text, to generate a prediction image;
constructing a prediction loss according to a difference between the sample target image and the prediction image; and
performing iterative training on the model based on the prediction loss until a model convergence condition is reached, to obtain the neural network model.

10. The method according to claim 5, wherein performing local fine adjustment on the similar image according to the target mask image and the reference image includes:
performing negation on the target mask image, to obtain a target inverse mask image corresponding to the target mask image;
performing mask processing on the similar image according to the target inverse mask image, to obtain a similar mask image;
performing noise addition processing on the similar mask image to obtain a similar noise image;
performing noise reduction processing on the similar noise image according to a feature image corresponding to the reference image, to obtain a feature image corresponding to the similar noise image; and
decoding the feature image corresponding to the similar noise image, to obtain the second image.

11. The method according to claim 10, wherein:
the noise reduction processing includes denoising processing for a plurality of consecutive times; and
performing noise reduction processing on the similar noise image includes:
integrating, through an attention mechanism, the feature image corresponding to the reference image in each process of performing denoising processing on the similar noise image, to obtain the feature image corresponding to the similar noise image, the feature image corresponding to the similar noise image including semantic information associated with the feature image corresponding to the reference image.

12. The method according to claim 1, wherein performing text expansion expression includes:
determining the difference object according to the difference information;
determining object relationship information between the difference object and each object in the reference image;
obtaining a global description text of the reference image and a target object description text of the difference object; and
performing text description based on the global description text, the target object description text, and the object relationship information, to obtain the difference description text.

13. The method according to claim 1, wherein obtaining the similarity between one image in the database and the reference image includes:
determining a reference cluster center to which the reference image belongs;
determining a feature category distance between a preconstructed image cluster center in the preset database and the reference cluster center, the preconstructed image cluster corresponding to the one image; and
determining, based on the feature category distance, the similarity between the one image and the reference image.

14. The method according to claim 1, wherein determining the difference information includes:
obtaining a first description text corresponding to the reference image;
obtaining a second description text corresponding to the similar image; and
generating the difference information based on a difference between the first description text and the second description text.

15. The method according to claim 14, wherein obtaining the first description text includes:
performing global description on the reference image through a first model, to generate a global description text of the reference image;
for each object in the reference image, processing, through a second model, a pixel area in which the object is located, to obtain an object description text corresponding to the object; and
determining the first description text according to the global description text of the reference image and the object description text corresponding to each object.

16. The method according to claim 1, wherein determining the target mask image includes:
determining the difference object according to the difference information; and
generating the target mask image based on the difference object.

17. A computer device comprising:
a processor; and
a memory storing a computer program that, when executed by the processor, causes the computer device to:
obtain a similarity between each image in a database and a reference image, and determine an image having a largest similarity in the database as a similar image;
determine difference information between the reference image and the similar image;
determine a target mask image, in the reference image, for the difference information, the target mask image highlighting a difference object that is in the reference image relative to the similar image and that is determined according to the difference information;
perform text expansion expression based on the difference object and the reference image, to obtain a difference description text, the difference description text describing a content difference between the reference image and the similar image; and
locally adjust the similar image according to the target mask image, the difference description text, and the reference image, to obtain a target image conforming to a content requirement of the reference image.

18. The computer device according to claim 17, wherein the computer program, when executed by the processor, further causes the computer device to, when locally adjusting the similar image:
perform noise addition processing on the similar image, and obtain a first similar noise image and a second similar noise image that are of adjacent time steps in the noise addition processing;
perform denoising processing on the first similar noise image according to the target mask image and the difference description text, to obtain a first image;
perform denoising processing on the second similar noise image according to the target mask image and the reference image, to obtain a second image; and
fuse the first image and the second image, to obtain the target image.

19. The computer device according to claim 18, wherein the computer program, when executed by the processor, further causes the computer device to, when performing denoising processing on the first similar noise image:
perform mask processing on the first similar noise image according to the target mask image, to obtain a mask noise image;
obtain a difference text vector corresponding to the difference description text;
perform noise reduction processing on the mask noise image according to the difference text vector, to obtain a feature image; and
decode the feature image, to obtain the first image.

20. A non-transitory computer-readable storage medium storing a plurality of instructions that, when executed by a processor, cause a computer device having the processor to:
obtain a similarity between each image in a database and a reference image, and determine an image having a largest similarity in the database as a similar image;
determine difference information between the reference image and the similar image;
determine a target mask image, in the reference image, for the difference information, the target mask image highlighting a difference object that is in the reference image relative to the similar image and that is determined according to the difference information;
perform text expansion expression based on the difference object and the reference image, to obtain a difference description text, the difference description text describing a content difference between the reference image and the similar image; and
locally adjust the similar image according to the target mask image, the difference description text, and the reference image, to obtain a target image conforming to a content requirement of the reference image.
